(19) United States
(12) Patent Application Publication
(10) Pub. No.: US 2025/0260481 A1
(43) Pub. Date: Aug. 14, 2025

(54) NETWORK NODE BROADCAST TRANSMISSIONS

(71) Applicant: QUALCOMM Incorporated, San Diego, CA (US)

(72) Inventors: Toru UCHINO, Zushi-shi (JP); Geetha Priya RAJENDRAN, Bangalore (IN); Prasad Reddy KADIRI, San Diego, CA (US); Bharat SHRESTHA, San Diego, CA (US); Umesh PHUYAL, San Diego, CA (US)

(21) Appl. No.: 18/441,751

(22) Filed: Feb. 14, 2024

(51) Int. Cl. H04B 7/185

(52) U.S. Cl. CPC H04B 7/18523

(57) ABSTRACT

Various aspects of the present disclosure generally relate to wireless communication. In some aspects, a network node may receive an information element that indicates, for a geographical area associated with the network node, a resolution for the geographical area to be used for a broadcast transmission by the network node or a portion of the geographical area to be used for the broadcast transmission by the network node. The network node may perform the broadcast transmission in accordance with the information element. Numerous other aspects are described.

### FIELD OF THE DISCLOSURE

Aspects of the present disclosure generally relate to wireless communication and specifically relate to techniques, apparatuses, and methods for network node broadcast transmissions.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

In some aspects, a method of wireless communication performed by a network node includes receiving an information element that indicates, for a geographical area associated with the network node, a resolution for the geographical area to be used for a broadcast transmission by the network node or a portion of the geographical area to be used for the broadcast transmission by the network node; and performing the broadcast transmission in accordance with the information element.

In some aspects, a method of wireless communication performed by an access and mobility management function (AMF) includes obtaining an indication of a geographical area associated with a network node; and transmitting an information element that indicates, for the geographical area, a resolution for the geographical area to be used for a broadcast transmission by the network node or a portion of the geographical area to be used for the broadcast transmission by the network node.

In some aspects, a method of wireless communication performed by a network function includes detecting that a network node is to become available for a service area associated with performing broadcast transmissions; and transmitting a request for the network node to perform a broadcast transmission in accordance with the network node becoming available for the service area.

In some aspects, a method of wireless communication performed by a network node includes performing one or more movements in a direction of a service area associated with broadcast transmissions by the network node; and receiving a request to perform a broadcast transmission in the service area in accordance with the one or more movements.

In some aspects, an apparatus for wireless communication at a network node includes one or more memories; and one or more processors, coupled to the one or more memories, configured to cause the network node to: receive an information element that indicates, for a geographical area associated with the network node, a resolution for the geographical area to be used for a broadcast transmission by the network node or a portion of the geographical area to be used for the broadcast transmission by the network node; and perform the broadcast transmission in accordance with the information element.

In some aspects, an apparatus for wireless communication at an AMF includes one or more memories; and one or more processors, coupled to the one or more memories, configured to cause the AMF to: obtain an indication of a geographical area associated with a network node; and transmit an information element that indicates, for the geographical area, a resolution for the geographical area to be used for a broadcast transmission by the network node or a portion of the geographical area to be used for the broadcast transmission by the network node.

In some aspects, an apparatus for wireless communication at a network function includes one or more memories; and one or more processors, coupled to the one or more memories, configured to cause the network function to: detect that a network node is to become available for a service area associated with performing broadcast transmissions; and transmit a request for the network node to perform a broadcast transmission in accordance with the network node becoming available for the service area.

In some aspects, an apparatus for wireless communication at a network node includes one or more memories; and one or more processors, coupled to the one or more memories, configured to cause the network node to: perform one or more movements in a direction of a service area associated with broadcast transmissions by the network node; and receive a request to perform a broadcast transmission in the service area in accordance with the one or more movements.

In some aspects, a non-transitory computer-readable medium storing a set of instructions for wireless communication includes one or more instructions that, when executed by one or more processors of a network node, cause the network node to: receive an information element that indicates, for a geographical area associated with the network node, a resolution for the geographical area to be used for a broadcast transmission by the network node or a portion of the geographical area to be used for the broadcast transmission by the network node; and perform the broadcast transmission in accordance with the information element.

In some aspects, a non-transitory computer-readable medium storing a set of instructions for wireless communication includes one or more instructions that, when executed by one or more processors of an AMF, cause the AMF to: obtain an indication of a geographical area associated with a network node; and transmit an information element that indicates, for the geographical area, a resolution for the geographical area to be used for a broadcast transmission by the network node or a portion of the geographical area to be used for the broadcast transmission by the network node.

In some aspects, a non-transitory computer-readable medium storing a set of instructions for wireless communication includes one or more instructions that, when executed by one or more processors of a network function, cause the network function to: detect that a network node is to become available for a service area associated with performing broadcast transmissions; and transmit a request for the network node to perform a broadcast transmission in accordance with the network node becoming available for the service area.

In some aspects, a non-transitory computer-readable medium storing a set of instructions for wireless communication includes one or more instructions that, when executed by one or more processors of a network node, cause the network node to: perform one or more movements in a direction of a service area associated with broadcast transmissions by the network node; and receive a request to perform a broadcast transmission in the service area in accordance with the one or more movements.

In some aspects, an apparatus for wireless communication includes means for receiving an information element that indicates, for a geographical area associated with the apparatus, a resolution for the geographical area to be used for a broadcast transmission by the apparatus or a portion of the geographical area to be used for the broadcast transmission by the apparatus; and means for performing the broadcast transmission in accordance with the information element.

In some aspects, an apparatus for wireless communication includes means for obtaining an indication of a geographical area associated with a network node; and means for transmitting an information element that indicates, for the geographical area, a resolution for the geographical area to be used for a broadcast transmission by the network node or a portion of the geographical area to be used for the broadcast transmission by the network node.

In some aspects, an apparatus for wireless communication includes means for detecting that a network node is to become available for a service area associated with performing broadcast transmissions; and means for transmitting a request for the network node to perform a broadcast transmission in accordance with the network node becoming available for the service area.

In some aspects, an apparatus for wireless communication includes means for performing one or more movements in a direction of a service area associated with broadcast transmissions by the apparatus; and means for receiving a request to perform a broadcast transmission in the service area in accordance with the one or more movements.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4 is a diagram illustrating an example of a regenerative satellite deployment and an example of a transparent satellite deployment in a non-terrestrial network.

FIG. 5 is a diagram illustrating an example of network node broadcasting in a large geographical area, in accordance with the present disclosure.

FIG. 6 is a diagram illustrating an example of network node broadcast transmissions, in accordance with the present disclosure.

FIG. 7 is a diagram illustrating examples of network node broadcasting with network node movement in a geographical area, in accordance with the present disclosure.

FIG. 8 is a diagram illustrating an example of network node broadcast transmissions, in accordance with the present disclosure.

FIG. 9 is a diagram illustrating examples of network node movement within a service area, in accordance with the present disclosure.

FIG. 10 is a diagram illustrating an example of multicast and broadcast services broadcasting, in accordance with the present disclosure.

FIG. 11 is a diagram illustrating an example process performed, for example, at a network node or an apparatus of a network node, in accordance with the present disclosure.

FIG. 12 is a diagram illustrating an example process performed, for example, at an access and mobility management function or an apparatus of an access and mobility management function, in accordance with the present disclosure.

FIG. 13 is a diagram illustrating an example process performed, for example, at a network function or an apparatus of a network function, in accordance with the present disclosure.

FIG. 14 is a diagram illustrating an example process performed, for example, at a network node or an apparatus of a network node, in accordance with the present disclosure.

FIG. 15 is a diagram of an example apparatus for wireless communication, in accordance with the present disclosure.

FIG. 16 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A non-terrestrial network (NTN) is a network that provides communication services using satellites or other non-terrestrial devices, rather than through traditional terrestrial infrastructure such as stationary cell towers. An NTN node may broadcast using one or more beams within an NTN cell. The cell may be associated with a multicast and broadcast services (MBS) service area or a network node tracking area (TA). In some cases, the NTN cell may be large and may cover a larger geographical area than is needed for a broadcast message. An NTN node may transmit a broadcast message within an intended geographical area. Additionally, the NTN node may transmit the broadcast message within an unintended geographical area that is larger than the intended geographical area. This may result in increased network resource usage, such as increased network signaling resources. A first user equipment (UE) located within the intended geographical area may receive the broadcast message. Additionally, a second UE located outside of the intended geographical area (for example, within the unintended geographical area) may receive the broadcast message. This may result in increased battery consumption by the second UE.

A relationship between the network node and the geographical area may be fixed within a terrestrial network. Thus, once the network node receives a broadcast request from an access and mobility management function (AMF), the network node can broadcast the message within the geographical area. However, in an NTN, the network node may leave the geographical area, for example, in accordance with a satellite movement. Thus, it may not be possible for the network node to transmit the broadcast message within the geographical area when the network node is no longer within the geographical area. In one example, an AMF may communicate with a first network node and a second network node. The AMF may instruct the first network node to broadcast within a geographical area. For example, the AMF may transmit, and the first network node may receive, a write-replace warning request message that instructs the first network node to transmit a broadcast message within the geographical area. At a later time, the first network node may leave the geographical area. The first network node may not be able to broadcast within the geographical area since the first network node is no longer located within the geographical area. In some examples, the second network node may be located within the geographical area. However, the second network node may not receive instructions from the AMF to transmit the broadcast message within the geographical area. Therefore, a UE may not receive the broadcast message from the first network node or the second network node.

Various aspects relate generally to wireless communications. Some aspects more specifically relate to network node broadcast transmissions. In some aspects, a network function (for example, an AMF) may obtain an indication of a geographical area associated with a network node. For example, the network function may obtain an indication of a geographical area within which the network node is able to perform broadcast transmissions. The network function may transmit, and the network node may receive, an information element (IE). The information element may indicate a resolution for the geographical area to be used for broadcast transmissions by the network node. Additionally, or alternatively, the information element may indicate a portion of the geographical area to be used for broadcast transmissions by the network node. The network node may perform broadcast transmissions in accordance with the information element. In some examples, the information element may be an information element that is to be used for broadcast transmissions by the network node or for multicast transmissions by the network node. For example, the information element may indicate a resolution for a geographical area to be used for broadcast transmissions by the network node or for multicast transmissions by the network node and/or may indicate a portion of the geographical area to be used for broadcast transmissions by the network node or for multicast transmissions by the network node. In this example, the network node may perform at least one of a broadcast transmission or a multicast transmission in accordance with the information element. In some other aspects, a network function (for example, the AMF, a cell broadcast center function (CBCF), or a public warning system interworking function (PWS-IWF)) may detect that a network node is to become available for a service area associated with performing broadcast transmissions. For example, the network function may detect that the network node is approaching a geographical area within which the network node is to transmit broadcast messages. The network function may transmit, and the network node may receive, a request for the network node to perform the broadcast transmissions upon the network node becoming available for the service area.

Particular aspects of the subject matter described in this disclosure can be implemented to realize one or more of the following potential advantages. In some examples, by enabling communication of the information element, the described techniques can be used to enable the network node to perform broadcast transmissions in accordance with a resolution for a geographical area. Additionally, or alternatively, by enabling communication of the information element, the described techniques can be used to enable the network node to perform broadcast transmissions in accordance with a portion of the geographical area. This may reduce network signaling and network resource usage. Additionally, or alternatively, this may reduce UE battery consumption for UEs that receive the broadcast signaling. In some examples, by enabling communication of the information element, the described techniques can be used to improve communication reliability for network nodes that are capable of moving in and out of a service area. For example, by enabling communication of the information element, the described techniques can be used to improve communication reliability for an NTN node that moves in and out of the geographical area. These example advantages, among others, are described in detail below.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

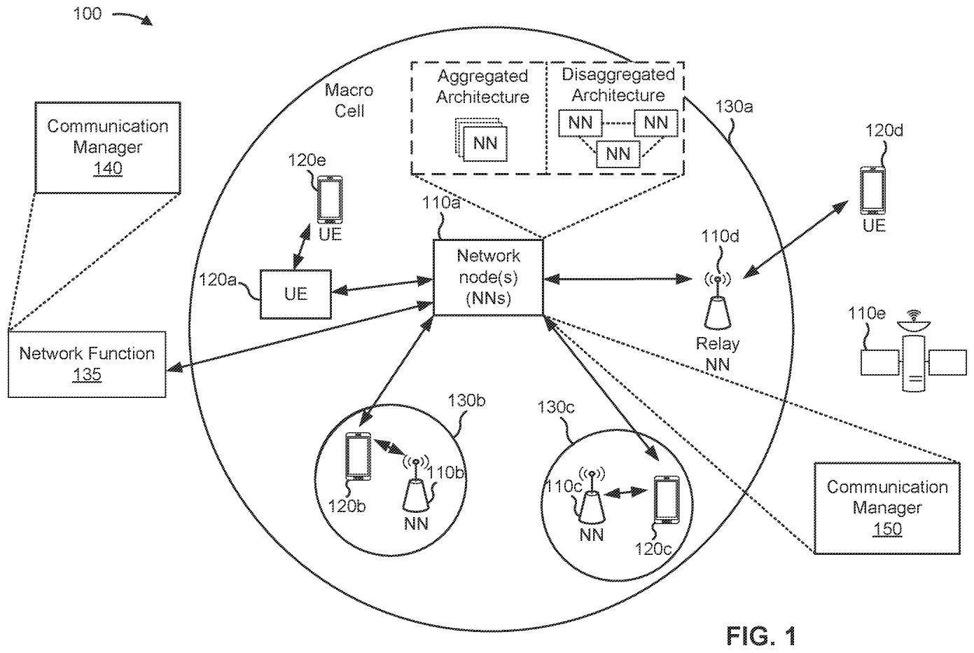

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (IFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

In some examples, the communication network 100 may include a network function 135. The network function 135 may be, or may include, AMF, a CBCF, and/or a PWS-IWF. The network function 135 may communicate with the network node 110. The network function 135 may include a communication manager 140.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the network function 135 may include a communication manager 140. In some aspects, as described in more detail elsewhere herein, the communication manager 140 may obtain an indication of a geographical area associated with a network node; and transmit an information element that indicates, for the geographical area, a resolution for the geographical area to be used for a broadcast transmission by the network node or a portion of the geographical area to be used for the broadcast transmission by the network node. In some other aspects, as described in more detail elsewhere herein, the communication manager 140 may detect that a network node is to become available for a service area associated with performing broadcast transmissions; and transmit a request for the network node to perform a broadcast transmission in accordance with the network node becoming available for the service area. Additionally, or alternatively, the communication manager 140 may perform one or more other operations described herein.

In some aspects, the network node 110 may include a communication manager 150. In some aspects, as described in more detail elsewhere herein, the communication manager 150 may receive an information element that indicates, for a geographical area associated with the network node, a resolution for the geographical area to be used for a broadcast transmission by the network node or a portion of the geographical area to be used for the broadcast transmission by the network node; and perform the broadcast transmission in accordance with the information element. In some other aspects, as described in more detail elsewhere herein, the communication manager 150 may perform one or more movements in a direction of a service area associated with broadcast transmissions by the network node; and receive a request to perform a broadcast transmission in the service area in accordance with the one or more movements. Additionally, or alternatively, the communication manager 150 may perform one or more other operations described herein.

As indicated above, FIG. 1 is provided as an example. Other examples may differ from what is described with regard to FIG. 1.

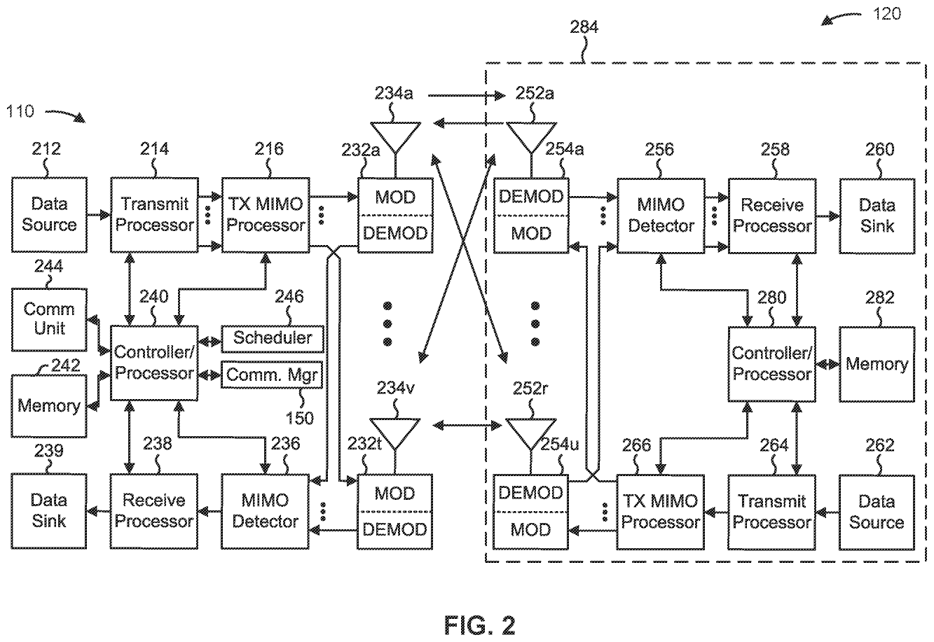

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

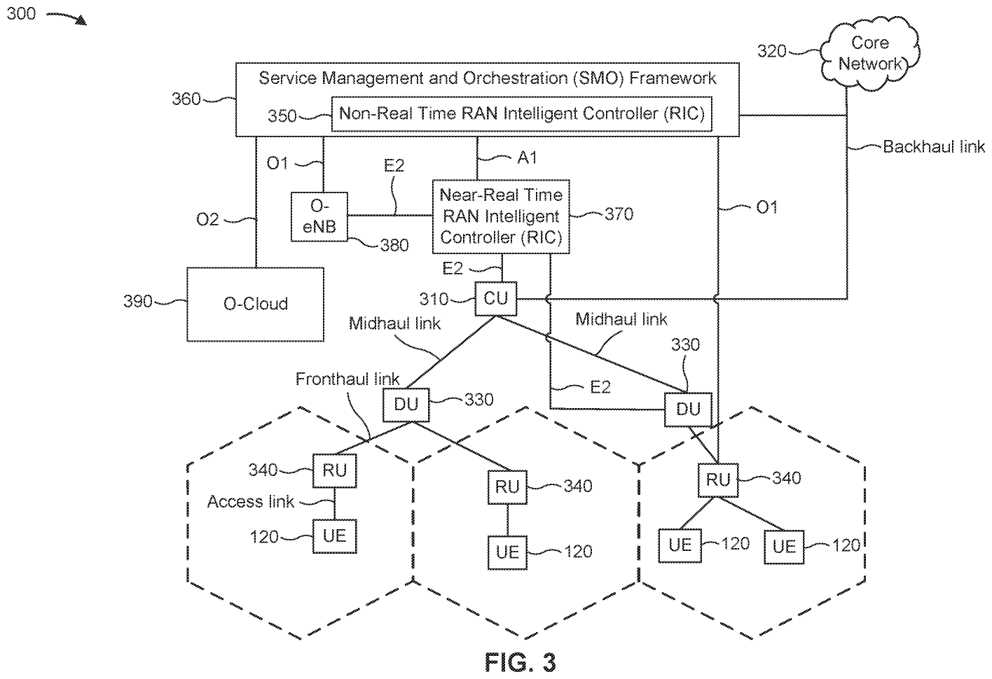

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

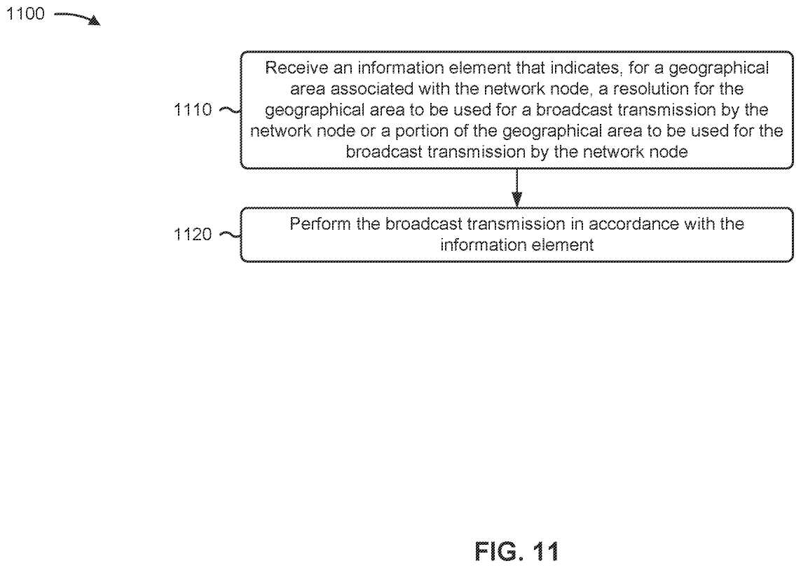

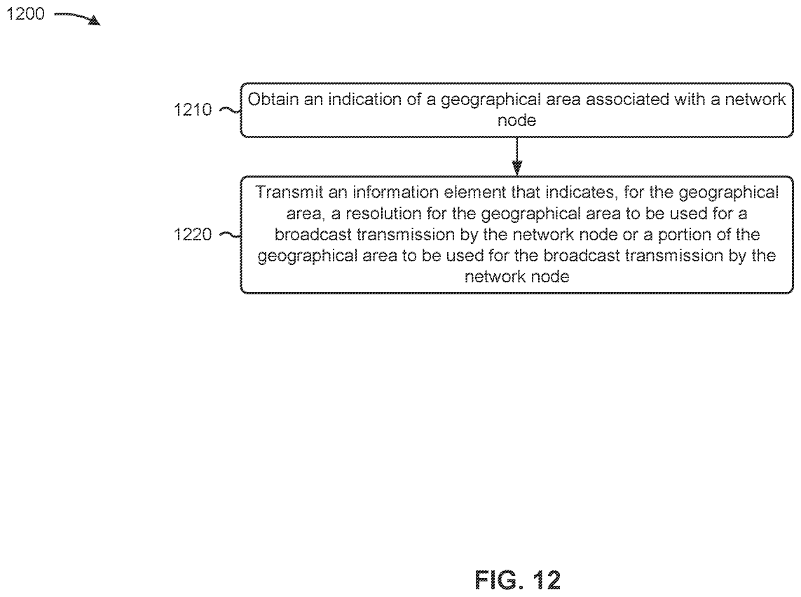

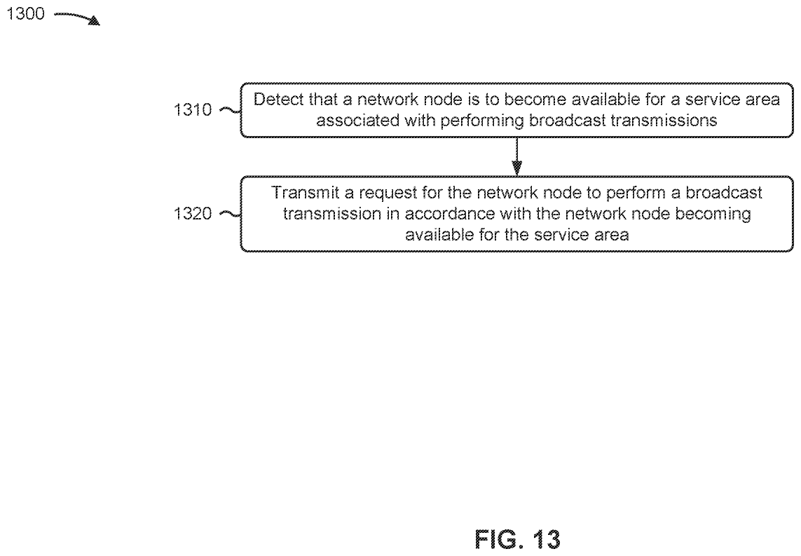

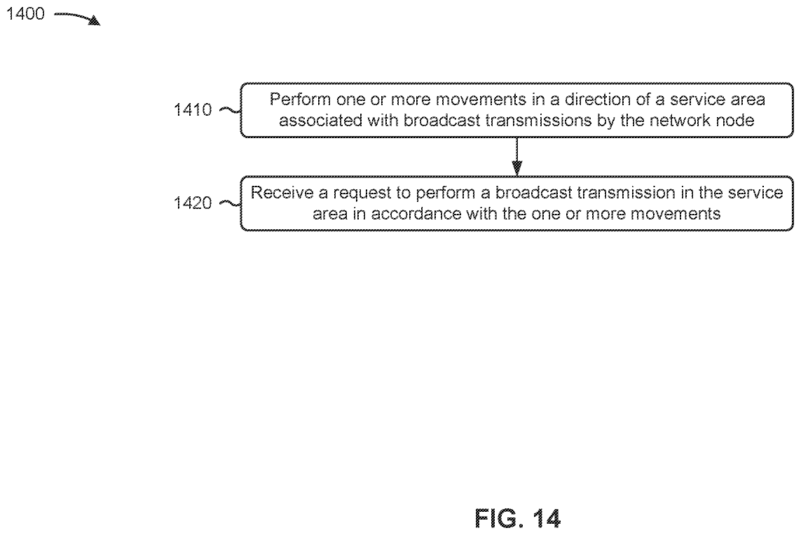

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with network node broadcast transmissions, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1100 of FIG. 11, process 1200 of FIG. 12, process 1300 of FIG. 13, process 1400 of FIG. 14, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1100 of FIG. 11, process 1200 of FIG. 12, process 1300 of FIG. 13, process 1400 of FIG. 14, or other processes as described herein. In some examples, executing instructions may include running the instructions, converting the instructions, compiling the instructions, and/or interpreting the instructions, among other examples.

In some aspects, the network node 110 includes means for receiving an information element that indicates, for a geographical area associated with the network node, a resolution for the geographical area to be used for a broadcast transmission by the network node or a portion of the geographical area to be used for the broadcast transmission by the network node; and/or means for performing the broadcast transmission in accordance with the information element. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

In some aspects, the network function 135 (e.g., the AMF) includes means for obtaining an indication of a geographical area associated with a network node; and/or means for transmitting an information element that indicates, for the geographical area, a resolution for the geographical area to be used for a broadcast transmission by the network node or a portion of the geographical area to be used for the broadcast transmission by the network node. In some aspects, the means for the network function 135 to perform operations described herein may include, for example, one or more of communication manager 140, transmit processor 214, TX MIMO processor 216, modem 232, antenna 234, MIMO detector 236, receive processor 238, controller/processor 240, memory 242, or scheduler 246.

In some aspects, the network function 135 includes means for detecting that a network node is to become available for a service area associated with performing broadcast transmissions; and/or means for transmitting a request for the network node to perform a broadcast transmission in accordance with the network node becoming available for the service area. In some aspects, the means for the network function 135 to perform operations described herein may include, for example, one or more of communication manager 140, transmit processor 214, TX MIMO processor 216, modem 232, antenna 234, MIMO detector 236, receive processor 238, controller/processor 240, memory 242, or scheduler 246.

In some aspects, the network node 110 includes means for performing one or more movements in a direction of a service area associated with broadcast transmissions by the network node; and/or means for receiving a request to perform a broadcast transmission in the service area in accordance with the one or more movements. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

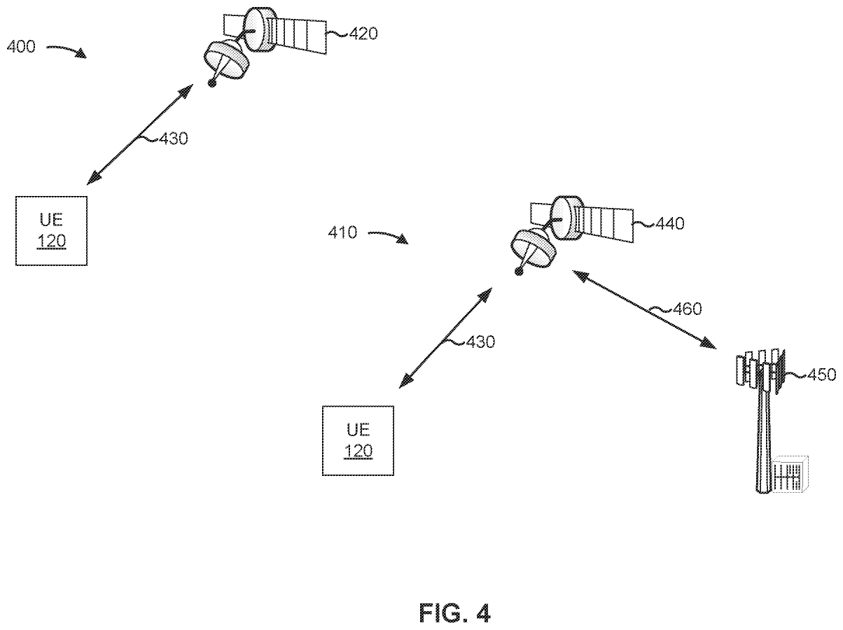

FIG. 4 is a diagram illustrating an example 400 of a regenerative satellite deployment and an example 410 of a transparent satellite deployment in a non-terrestrial network.

Example 400 shows a regenerative satellite deployment. In example 400, a UE 120 is served by a satellite 420 via a service link 430. For example, the satellite 420 may include a network node 110 (e.g., network node 110a) or a gNB. In some aspects, the satellite 420 may be referred to as a non-terrestrial base station, a regenerative repeater, or an on-board processing repeater. In some aspects, the satellite 420 may demodulate an uplink radio frequency signal, and may modulate a baseband signal derived from the uplink radio signal to produce a downlink radio frequency transmission. The satellite 420 may transmit the downlink radio frequency signal on the service link 430. The satellite 420 may provide a cell that covers the UE 120.

Example 410 shows a transparent satellite deployment, which may also be referred to as a bent-pipe satellite deployment. In example 410, a UE 120 is served by a satellite 440 via the service link 430. The satellite 440 may be a transparent satellite. The satellite 440 may relay a signal received from gateway 450 via a feeder link 460. For example, the satellite may receive an uplink radio frequency transmission, and may transmit a downlink radio frequency transmission without demodulating the uplink radio frequency transmission. In some aspects, the satellite may frequency convert the uplink radio frequency transmission received on the service link 430 to a frequency of the uplink radio frequency transmission on the feeder link 460, and may amplify and/or filter the uplink radio frequency transmission. In some aspects, the UEs 120 shown in example 400 and example 410 may be associated with a Global Navigation Satellite System (GNSS) capability or a Global Positioning System (GPS) capability, though not all UEs have such capabilities. The satellite 440 may provide a cell that covers the UE 120.

The service link 430 may include a link between the satellite 440 and the UE 120, and may include one or more of an uplink or a downlink. The feeder link 460 may include a link between the satellite 440 and the gateway 450, and may include one or more of an uplink (e.g., from the UE 120 to the gateway 450) or a downlink (e.g., from the gateway 450 to the UE 120). An uplink of the service link 430 may be indicated by reference number 430-U (not shown in FIG. 4) and a downlink of the service link 430 may be indicated by reference number 430-D (not shown in FIG. 4). Similarly, an uplink of the feeder link 460 may be indicated by reference number 460-U (not shown in FIG. 4) and a downlink of the feeder link 460 may be indicated by reference number 460-D (not shown in FIG. 4).

The feeder link 460 and the service link 430 may each experience Doppler effects due to the movement of the satellites 420 and 440, and potentially movement of a UE 120. These Doppler effects may be significantly larger than in a terrestrial network. The Doppler effect on the feeder link 460 may be compensated for to some degree, but may still be associated with some amount of uncompensated frequency error. Furthermore, the gateway 450 may be associated with a residual frequency error, and/or the satellite 420/440 may be associated with an on-board frequency error. These sources of frequency error may cause a received downlink frequency at the UE 120 to drift from a target downlink frequency.

As indicated above, FIG. 4 is provided as an example. Other examples may differ from what is described with regard to FIG. 4.

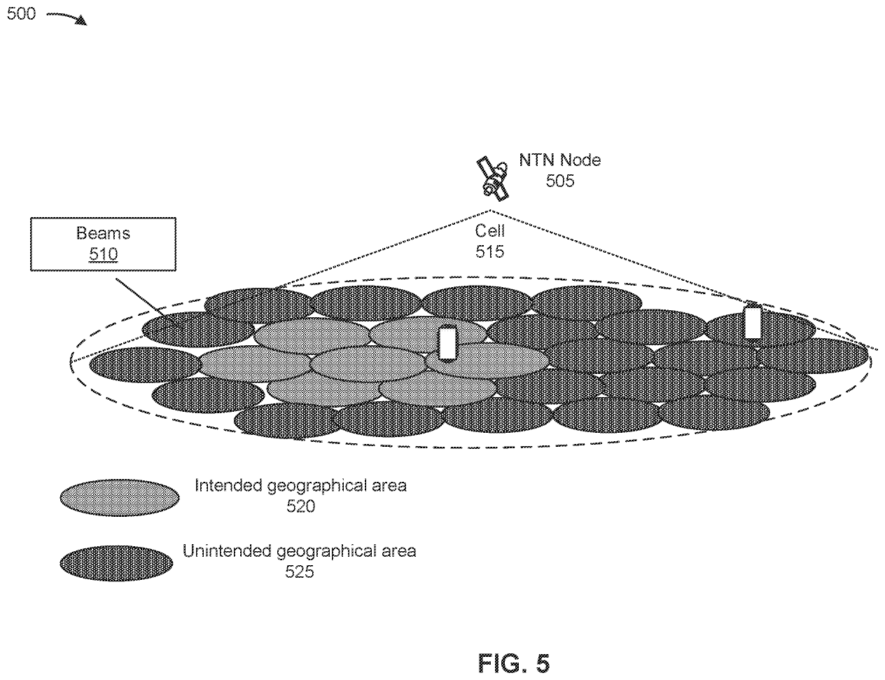

FIG. 5 is a diagram illustrating an example 500 of network node broadcasting in a large geographical area, in accordance with the present disclosure. An NTN node 505 may broadcast using one or more beams 510 within an NTN cell 515. The cell 515 may be associated with a multicast and broadcast services (MBS) service area or a network node tracking area (TA). In some cases, the NTN cell may be large and may cover a larger geographical area than is needed for a broadcast message. As shown in example 500, the NTN node 505 may transmit a broadcast message to an intended geographical area 520 and to an unintended geographical area 525. This may result in increased network resources, such as increased network signaling resources. A first UE 120-1 located within the intended geographical area 520 may receive the broadcast message. Additionally, a second UE 120-2 located within the unintended geographical area 525 may receive the broadcast message. This may result in increased UE battery consumption for the UE 120-2. The increased network signaling and/or increased UE battery consumption may occur in an NTN network shown in the example 500 and/or may occur within any other type of network (including, but not limited to, terrestrial networks).

As indicated above, FIG. 5 is provided as an example. Other examples may differ from what is described with regard to FIG. 5.

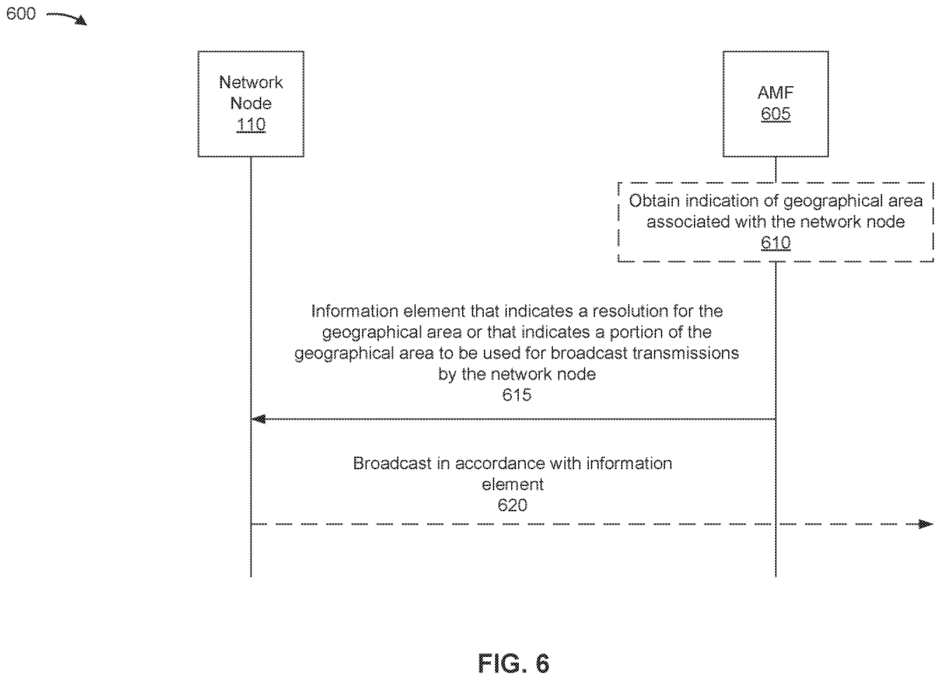

FIG. 6 is a diagram illustrating an example 600 of network node broadcast transmissions, in accordance with the present disclosure. The network node 110 may communicate with an AMF 605.

As shown by reference number 610, the AMF 605 may obtain an indication of a geographical area associated with the network node 110. For example, the AMF 605 may obtain an indication of a geographical area within which the network node 110 is able to perform broadcast transmissions. In some aspects, the geographical area may include an intended geographical area and an unintended geographical area, as described herein.

As shown by reference number 615, the AMF 605 may transmit, and the network node 110 may receive, an information element. In some aspects, the information element may include a resolution for the geographical area to be used for broadcast transmissions by the network node 110. For example, the information element may indicate a finer resolution of an area than a cell, such as a beam or a beam group. In some aspects, the AMF 605 may inform the network node of a beam (or a beam group) to be used when broadcasting. The beam information may be “mapped beam” or “mapped beam group” where a beam or beam group corresponds to a specific geographical area. The AMF 605 (or an upper layer node such as a CBCF or a PWS-IWF) may be configured with a relationship between the mapped beam and the geographical area. The network node 110 may broadcast a message to the geographical area corresponding to the indicated mapped beam. In some examples, the mapped beam may be indexed with a unique beam identifier (ID) across a plurality of cells. In some other aspects, the mapped beam may be indexed with a unique beam ID within a particular cell. The network node may respond with an indication of whether a resource reservation was successful or unsuccessful per beam (or per beam group). In one example, the AMF 605 may transmit, and the network node 110 may receive, a write-replace warning request or a broadcast session setup request that includes a tracking area indicator, a cell indicator, and/or a beam indicator. The network node 110 may transmit, and the AMF 605 may receive, a write-replace warning response or a broadcast session setup response that includes the tracking area indicator, the cell indicator, and/or the beam indicator.

In some aspects, the information element may indicate a portion of the geographical area to be used for broadcast transmissions by the network node 110. For example, the information element may indicate a specific geographical area within which the network node 110 is to perform broadcast transmissions. The AMF 605 may inform the network node 110 of target geographical area information for broadcasting. The target geographical area information may include, for example, a list of countries, regions, or an arbitrary zone (which may be configured, for example, via OAM). The network node 110 may transmit the broadcast message within the indicated geographical area. The network node may respond with an indication of whether a resource reservation was successful or unsuccessful for each index of the items in the list. In one example, the AMF 605 may transmit, and the network node 110 may receive, a write-replace warning request or a broadcast session setup request that includes a tracking area indicator, a cell indicator, and/or a geographical information indicator. The network node 110 may transmit, and the AMF 605 may receive, a write-replace warning response or a broadcast session setup response that includes the tracking area indicator, the cell indicator, and/or the geographical information indicator.

As shown by reference number 620, the network node 110 may perform a broadcast transmission in accordance with the information element. For example, the network node 110 may perform a broadcast transmission based at least in part on the resolution for the geographical area and/or based at least in part on the portion of the geographical area indicated in the information element.

As indicated above, FIG. 6 is provided as an example. Other examples may differ from what is described with regard to FIG. 6.

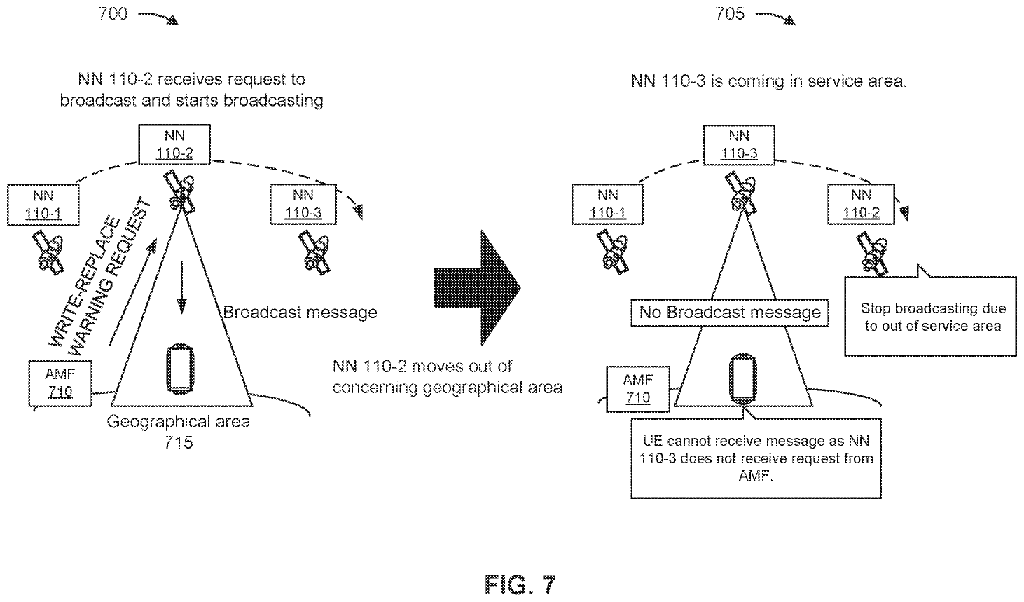

FIG. 7 is a diagram illustrating examples 700 and 705 of network node broadcasting with network node movement in a geographical area, in accordance with the present disclosure.

A relationship between a network node 110 and a geographical area may be fixed within a terrestrial network. Thus, once the network node 110 receives a broadcast request from an AMF, the network node 110 can broadcast the message within the geographical area. However, in an NTN, the network node 110 may leave the geographical area, for example, in accordance with a satellite movement. Thus, it may not be possible for the network node 110 to transmit the broadcast message within the geographical area when the network node 110 is no longer within the geographical area. As shown in example 700, an AMF 710 may communicate with a network node 110-1, a network node 110-2, and a network node 110-3. The AMF 710 may instruct the network node 110-2 to broadcast within a geographical area 715. For example, the AMF 710 may transmit, and the network node 110-2 may receive, a write-replace warning request message that instructs the network node 110-2 to transmit a broadcast message within the geographical area 715. As shown in example 705, at a later time, the network node 110-2 may leave the geographical area 715. The network node 110-2 may not be able to broadcast within the geographical area 715 since the network node 110-2 is no longer located within the geographical area 715. In some examples, another network node, such as the network node 110-3, may be located within the geographical area 715. However, the network node 110-3 may not receive instructions from the AMF 710 to transmit the broadcast message within the geographical area 715. Therefore, the UE 120 may not receive the broadcast message from the network node 110-2 or the network node 110-3.

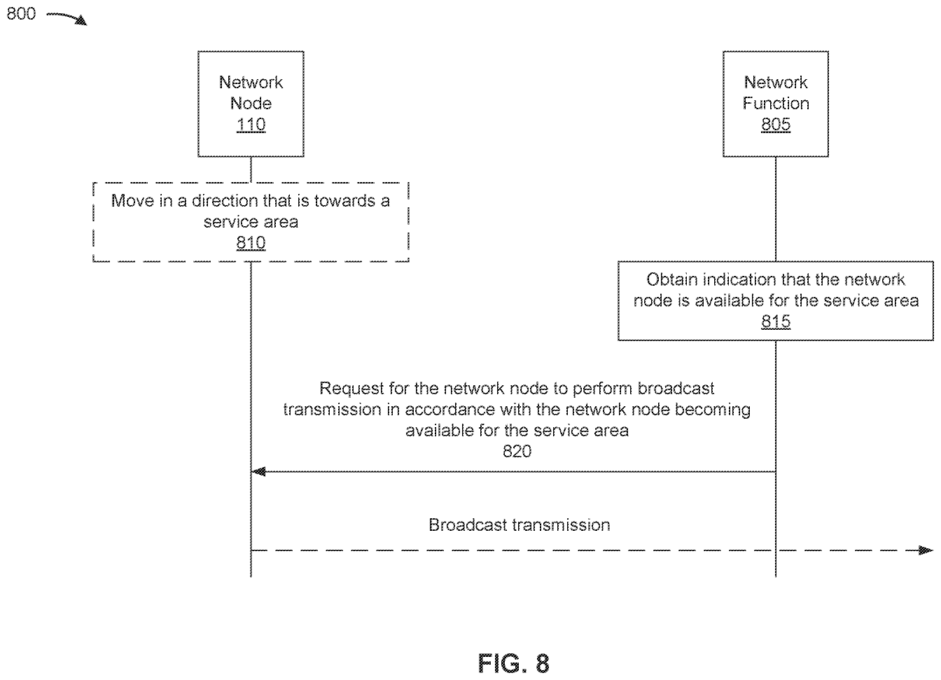

FIG. 8 is a diagram illustrating an example 800 of network node broadcast transmissions, in accordance with the present disclosure. The network node 110 may communicate with a network function 805. In some examples, the network function 805 may be an AMF. In some other examples, the network function 805 may be a CBCF or PWS-IWF. Additional details are described below.

As shown by reference number 810, the network node 110 may perform one or more movements in a direction of a service area (for example, a geographical area). As shown by reference number 815, the network function 805 may detect that the network node 110 is to become available for a service area. For example, the network function 805 may detect that the network node 110 is to become available for a service area associated with broadcast transmissions by the network node 110. As shown by reference number 820, the network function 805 may transmit, and the network node 110 may receive, a request for the network node 110 to perform a broadcast transmission in accordance with the network node 110 becoming available for the service area.

In a first example, the network function 805 may be an AMF or a mobility management entity (MME). The AMF may detect that the network node 110 is to become available for the service area, and may transmit a request for the network node 110 to broadcast a message upon the network node 110 becoming available for the service area.

In some aspects, the AMF may select the network node 110 for broadcasting. In some examples, the AMF may select the network node 110 for broadcasting based at least in part on satellite movement information. For example, the AMF may select the network node 110 for broadcasting based at least in part on an availability of the network node 110, such as based at least in part on ephemeris information of each satellite where the network node 110 is located and/or based at least in part on timing information associated with the network node being available (e.g., reference information plus duration). The information may be provided by OAM, an information server, or an upper layer node. In some other examples, the AMF may select the network node 110 for broadcasting based at least in part on information received from the network node 110. For example, the AMF may select the network node 110 for broadcasting based at least in part on an availability of the network node 110 (e.g., an endpoint of the network node 110, a transport network layer (TNL) identifier, a TA, a cell, a beam, an emergency area, an MBS area) for broadcasting and/or based at least in part on timing information where the network node 110 (e.g., an endpoint of the network node 110, a transport network layer (TNL) identifier, a TA, a cell, a beam, an emergency area, an MBS area) is available (e.g., reference information plus duration).

In some aspects, the network node 110 may use multicast transport. The network node 110 may need to be aware of an endpoint of a multicast/broadcast (MB-) user plane function (UPF) when the network node 110 enters (or re-enters) the service area. In some examples, the network node 110 may retain the endpoint identifier even if the network node 110 leaves the service area. When the network node 110 re-enters the service area, the network node 110 may determine that the endpoint is available. If multiple UPFs serve the same geographical area, the network node 110 may select a UPF (except for the previous UPF). In some other examples, the AMF may provide the network node 110 with the endpoint identifier. The AMF may trigger an MBS broadcast session setup procedure to inform the endpoint when the network node 110 comes to the service area (or activates the endpoint). If multiple UPFs serve the same specific geographical area, the network node 110 may select a UPF (except for the previous UPF).

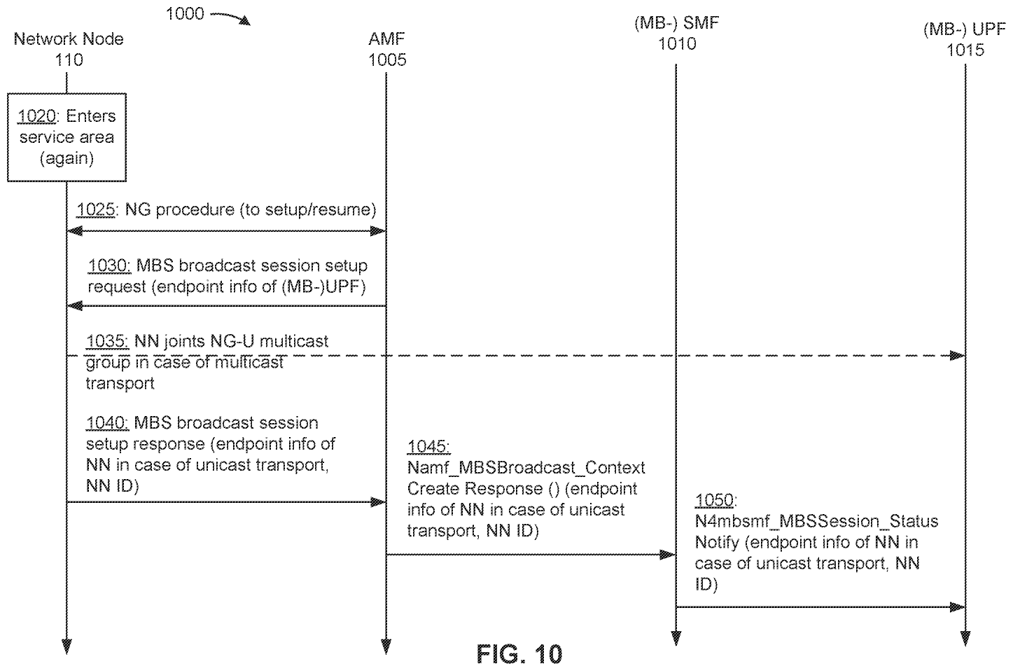

In some aspects, the network node 110 may use unicast transport. Both the network node 110 and the (MB-)UPF may need to be aware of endpoints of each other when the network node 110 comes to the service area (again). For the network node 110, similar operations can be applied as in the multicast transport example above. For the UPF, in a first option, the UPF retains the endpoint identifier of each network node even if the network node goes out of the service area. The UPF stores the mapping of the endpoint and the network node and then delivers an MBS message to the endpoint of the network nodes available in the service area. In a second option, the AMF provides the endpoint identifier. The AMF may trigger an MBS broadcast session setup procedure to inform the endpoint when the network node comes into the service area (or activates the endpoint). The network node may include the endpoint and the AMF may inform the (MB-)UPF via a (MB-) session management function (SMF). If multiple UPFs serve the same geographical area, the network node may select one UPF (except for the previous UPF). In a third option, the network node may provide the endpoint identifier. The network node may send a message to indicate an endpoint of the network node to the AMF, and the AMF may send the indication of the endpoint to the (MB-)UPF via the (MB-)SMF. Additional details regarding these features are described, for example, in connection with FIG. 10.

In some aspects, a network node may be split between a control plane portion (which may be referred to as a network node central unit control plane (NN-CU-CP)) and a user plane portion (which may be referred to as a network node central unit user plane (NN-CU-UP)). In this example, the endpoint assignment may be performed by the NN-CU-UP and the assigned endpoint address may be informed by the NN-CU-CP to a core network node (for example, the AMF).

In some examples, the NN-CU-UP may retain the endpoint information for configuring the endpoint of the (MB-)UPF at the NN-CU-CP. Once obtained, the NN-CU-UP retains the endpoint information of the (MB-)UPF even if the NN-CU-UP is out of the service area. When the NN-CU-UP comes to the service area, the NN-CU-UP considers it is available for MBS broadcast. The NN-CU-UP may receive activation commands from other nodes, such as gNB-CU-CP. In some other examples, the NN-CU-CP may retain and inform the NN-CU-UP of the endpoint. When the NN-CU-UP leaves the service area, the information may be discarded. However, the NN-CU-UP may retain the information. When it comes into the service area, the NN-CU-CP sends the stored endpoint information to a gNB-CU-UP. This may be done via an existing procedure, such as via a bearer context setup request or bearer context modification request. The endpoint information may be sent with MBS session ID, MBS area ID, and/or the (MB-)UPF ID, among other examples.

In some examples, the NN-CU-CP may trigger obtaining the endpoint of the NN-CU-UP. When the NN-CU-CP detects that it is in the service area, it may request endpoint information from the NN-CU-UP. This may be done via an existing procedure, such as via a bearer context setup request or bearer context modification request. In some other examples, the NN-CU-UP may trigger obtaining the endpoint of the NN-CU-UP. When the NN-CU-UP considers that it is in the service area, it may send its endpoint information to the NN-CU-CP. This may be done via an existing procedure, such as via a bearer context modification required message.

In some examples, as described herein, the network node 110 may leave the service area. In some examples, the network node 110 and/or the AMF may obtain information that indicates whether the network node 110 or the AMF is to retain or discard the received messages for broadcasting. For example, in NTN, the network node 110 may retain the received message for broadcasting. In some other examples, the network node 110 and/or the AMF may indicate whether the network node 110 retains or discards the received message for broadcasting. This indication may be performed, for example, using a RAN configuration update process. When the network node 110 retains the message, the network node 110 may continue counting (up/down) validity time (e.g., number of broadcasts) even if the network node 110 is outside of the service area, such that the message is discarded at an appropriate time. For either option, when the network node 110 leaves the service area, the network node 110 may inform the AMF of how many times it has been broadcasted, remaining times for broadcasting, or how many times a subsequent network node is to broadcast the message, among other examples.

In some examples, when the network node 110 retains the message, the network node 110 may continue counting (up or down) validity time (for example, number of broadcasts) even outside of the service area such that the message is discarded at the appropriate time. When the network node 110 leaves the service area, the network node 110 may inform the AMF of how many times it has been broadcasted, remaining times for broadcasting, or how many times a subsequent network node is to broadcast the message, among other examples. Discard or retain may be selected per TA, per cell, per service, per QoS, or per-message.

When the network node 110 is moving due to being associated with a satellite, the network node 110 may perform broadcasting to target a geographical area in appropriate timing. In some aspects, the network node 110 may stop or start (e.g., re-start) based at least in part on an indication from other nodes. In some examples, the network node 110 may receive, from another node (for example, the AMF), the stop or start indication. The AMF may send the indication based at least in part on a trigger. The indication to start (e.g., re-start) may be sent, for example, when a broadcast request is sent, when a broadcast modification is sent, or when it is detected that the network node 110 is incoming to the service area (e.g., when the network node 110 becomes available for the concerning area, TA, or cell). The indication to stop may be sent, for example, when an upper layer node (e.g., an MBS node) is requested, when a broadcast modification request is sent, or when it is detected that the network node 110 is outgoing to the service area (e.g., when the network node becomes unavailable for the concerning area, TA, or cell). The indication contents may include the source node ID and the target node ID, identifier information (such as a serial number, a session ID, a message ID, or a sequence number), area information (such as geographical, regional, or zone area information), TA information, cell information, or beam information), a stop or start indication (which may be per-network node, per area ID, per TA, per cell, per beam, per session, or per message), and/or a time-to-trigger indication. The network node 110 may apply a stop or start behavior immediately upon reception of the indication. Alternatively, the network node 110 may apply the indication after a time period (e.g., after a time-to-trigger). In some examples, “stop” and “start” may include “suspend” and “resume,” respectively. Additionally, or alternatively, “stop” and “start” may be indicated as “deactivate” and “activate” (or “re-activate”) or “suspended” and “resumed”. The network node 110 may send a response to the indication (e.g., accept, reject, or error). The response may be per network node, per area ID, per TA, per cell, per beam, per session, or per message. In some examples, the network node 110 may stop or start broadcasting based at least in part on timing information. The timing information may be similar to the indication described above in connection with the network node 110 receiving the indication, but may not include a stop or start indication. The timing information may be, for example, an absolute timing to stop and/or start (e.g., re-start), or may be a reference time (represented in absolute time) plus a duration. If the reference time is not provided, the network node 110 may consider that the reference time is information reception timing, response transmission timing, or timing when the network node 110 becomes available or unavailable for the target area, TA, cell, or beam. If a duration is not provided, the network node 110 may consider the duration to be set to infinity. In some aspects, the network node 110 may stop or start (e.g., re-start) based at least in part on information stored at the network node 110. For example, the network node 10 may stop or start based at least in part on the network node 110 becoming available or unavailable for the target cell, TA, cell, or beam. Additionally, or alternatively, the network node 110 may stop or start based at least in part on a memory size or a processing power available at the network node 110. In some aspects, different options can be used for stop and start. For example, the indication can be used for start, and the information stored at the network node 110 can be used for stop. The indication or information can be indicated or configured, for example, by a CN such as the AMF or an OAM.

In some aspects, a proxy node may be configured to handle (e.g., monitor) the movement of the network node 110. In this example, the proxy node may perform one or more of the operations described above as being performed by the AMF. For example, the proxy node may buffer a broadcast message received from the AMF and may deliver the message to the appropriate network nodes for serving a specific geographical area. The proxy node may behave as the AMF from the perspective of the network node 110. The AMF may not be aware of the movement of the network node 110 (e.g., a mapped TA or cell is used, and the proxy node performs the mapping between the mapped TA or cell and the Uu TA or cell). In some examples, the proxy node may handle broadcast services only. In some other examples, the proxy node may handle other types of transmissions.

In a second example, the network function 805 may be an upper layer node, such as a CBCF or a PWS-IWF. The upper layer node may send the request message to the network node 110 when the network node 110 is coming into the service area. In some aspects, the upper layer node may sent the request based at least in part on satellite movement information. The upper layer node may be aware of the availability of the network node 110 (or the endpoint of the network node 110 or TNL ID). The upper layer node may send the request based at least in part on ephemeris information of each satellite where the network node 110 is located and/or based at least in part on a time at which the network node is available (e.g., using reference information plus a duration). The information may be provided by an OAM, an information server, or another upper layer node, among other examples. In some other aspects, the upper layer node may send the request based at least in part on information from the AMF. For example, the upper layer node may receive, from the AMF, an availability of the network node 110 (such as the network node endpoint, TNL ID, TA, cell, beam, emergency area, or MBS area) for broadcasting and/or may send timing information where the network node 110 (such as the network node endpoint, TNL ID, TA, cell, beam, emergency area, or MBS area) is available (e.g., using reference information plus a duration). The information may be provided in the form of a failure message from the AMF. In this example, the cause value may be indicated as “satellite movement.” The information may be provided per service, per service group, per message, or per message group, among other examples.

As indicated above, FIG. 8 is provided as an example. Other examples may differ from what is described with regard to FIG. 8.

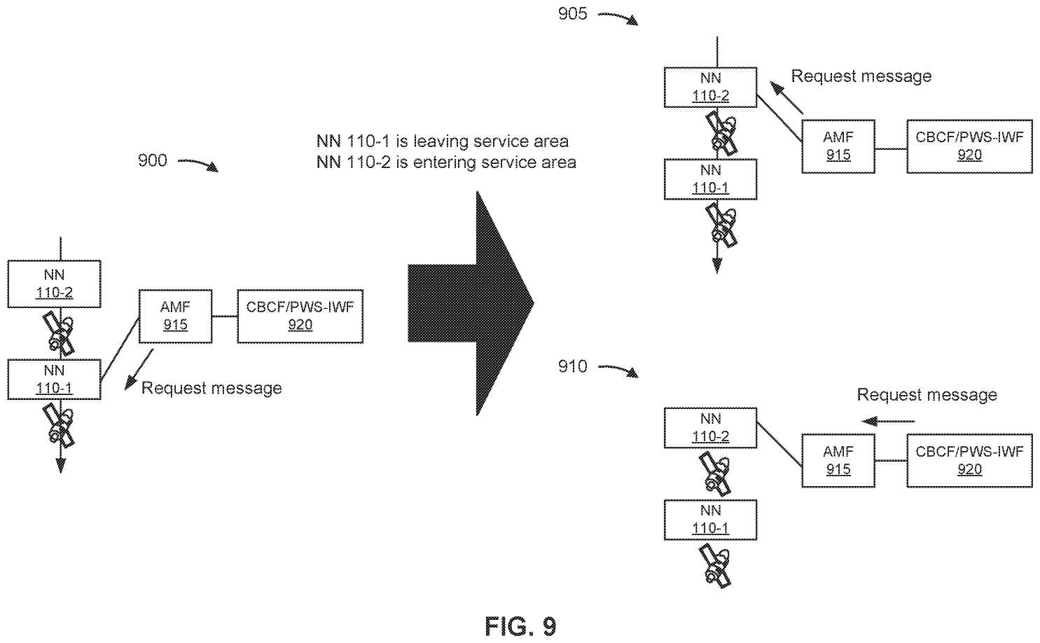

FIG. 9 is a diagram illustrating examples 900, 905 and 910 of network node movement within a service area, in accordance with the present disclosure. As shown in example 900, an AMF 915 may transmit, to a first network node 110-1 that is within a service area, a request for the first network node 110-1 to perform a broadcast transmission. As shown in examples 905 and 910, the first network node 110-1 may move out of the service area, and a second node 110-2 may move into the service area. In example 905, the AMF 915 may generate a request message that indicates for the second network node 110-2 to perform the broadcast transmission within the service area. The AMF 915 may transmit the request message to the second network node 110-2. In example 910, a CBCF/PWS-IWF 920 may generate a request message that indicates for the second network node 110-2 to perform the broadcast transmission within the service area. The CBCF/PWS-IWF 920 may transmit the request message to the AMF 915, and the AMF 915 may transmit the request message to the second network node 110-2.

As indicated above, FIG. 9 is provided as an example. Other examples may differ from what is described with regard to FIG. 9.

FIG. 10 is a diagram illustrating an example 1000 of multicast and broadcast services broadcasting, in accordance with the present disclosure. The network node 110 may communicate with an AMF 1005, an (MB-)SMF 1010, and/or an (MB-)UPF 1015. As shown by reference number 1020, the network node may become available for a service area. As shown by reference number 1025, the network node 110 and the AMF 1005 may perform an NG procedure. As shown by reference number 1030, the AMF 1005 may transmit, and the network node 110 may receive, an MBS broadcast session setup request. The MBS broadcast session setup request may include endpoint information of the (MB-)UPF 1015. As shown by reference number 1035, the network node 110 may communicate with the (MB-)UPF 1015 to join an NG-U multicast group in case of multicast transport. As shown by reference number 1040, the network node 110 may transmit, and the AMF 1005 may receive, an MBS broadcast session setup response. The MBS broadcast session setup response may include the endpoint information of the network node in case of unicast transport and/or may include the network node ID. As shown by reference number 1045, the AMF 1005 may transmit, and the (MB-)SMF 1010 may receive, an Namf_MBSBroadcast_ContextCreate message. The Namf_MBSBroadcast_ContextCreate message may include the endpoint information of the network node in case of unicast transport and/or may include the network node ID. As shown by reference number 1050, the (MB-)SMF 1010 may transmit, and the (MB-) UPF 1015 may receive, an N4mbsmf_MBSSession_StatusNotify message. The N4mbsmf_MBSSession_StatusNotify message may include the endpoint information of the network node in case of unicast transport and/or may include the network node ID.

As indicated above, FIG. 10 is provided as an example. Other examples may differ from what is described with regard to FIG. 10.

FIG. 11 is a diagram illustrating an example process 1100 performed, for example, at a network node or an apparatus of a network node, in accordance with the present disclosure. Example process 1100 is an example where the apparatus or the network node (e.g., network node 110) performs operations associated with network node broadcast transmissions.

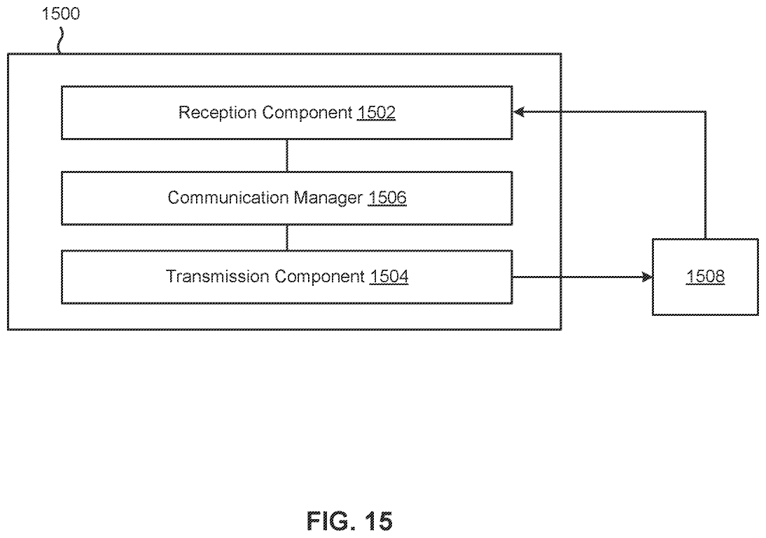

As shown in FIG. 11, in some aspects, process 1100 may include receiving an information element that indicates, for a geographical area associated with the network node, a resolution for the geographical area to be used for a broadcast transmission by the network node or a portion of the geographical area to be used for the broadcast transmission by the network node (block 1110). For example, the network node (e.g., using reception component 1502 and/or communication manager 1506, depicted in FIG. 15) may receive an information element that indicates, for a geographical area associated with the network node, a resolution for the geographical area to be used for a broadcast transmission by the network node or a portion of the geographical area to be used for the broadcast transmission by the network node, as described above.

As further shown in FIG. 11, in some aspects, process 1100 may include performing the broadcast transmission in accordance with the information element (block 1120). For example, the network node (e.g., using communication manager 1506, depicted in FIG. 15) may perform the broadcast transmission in accordance with the information element, as described above.

Process 1100 may include additional aspects, such as any single aspect or any combination of aspects described below and/or in connection with one or more other processes described elsewhere herein.

In a first aspect, receiving the information element comprises receiving, from an AMF, an indication of the resolution for the geographical area to be used for the broadcast transmission by the network node.

In a second aspect, alone or in combination with the first aspect, the indication of the resolution for the geographical area includes an indication of a mapped beam or a mapped beam group associated with the geographical area.

In a third aspect, alone or in combination with one or more of the first and second aspects, performing the broadcast transmission in accordance with the information element comprises performing the broadcast transmission using the mapped beam or the mapped beam group.

In a fourth aspect, alone or in combination with one or more of the first through third aspects, the mapped beam or the mapped beam group is indexed with a unique beam identifier associated with a plurality of cells or a unique beam identifier within a cell associated with the network node.

In a fifth aspect, alone or in combination with one or more of the first through fourth aspects, process 1100 includes transmitting, to the AMF, an indication of a successful resource reservation or an indication of an unsuccessful resource reservation associated with the mapped beam or the mapped beam group.

In a sixth aspect, alone or in combination with one or more of the first through fifth aspects, receiving the information element comprises receiving, from an AMF, an indication of the portion of the geographical area to be used for the broadcast transmission by the network node.

In a seventh aspect, alone or in combination with one or more of the first through sixth aspects, the indication of the portion of the geographical area is an indication of a target geographical area that includes at least one of a country indicator, a region indicator, or a zone indicator.

In an eighth aspect, alone or in combination with one or more of the first through seventh aspects, performing the broadcast transmission in accordance with the information element comprises performing the broadcast transmission within the portion of the geographical area.

In a ninth aspect, alone or in combination with one or more of the first through eighth aspects, process 1100 includes transmitting, to the AMF, an indication of a successful resource reservation or an indication of an unsuccessful resource reservation for one or more indexes associated with the portion of the geographical area.

In a tenth aspect, alone or in combination with one or more of the first through ninth aspects, the network node is a non-terrestrial network node.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at an AMF or an apparatus of an AMF, in accordance with the present disclosure. Example process 1200 is an example where the apparatus or the AMF (e.g., the AMF associated with the network function 135) performs operations associated with network node broadcast transmissions.

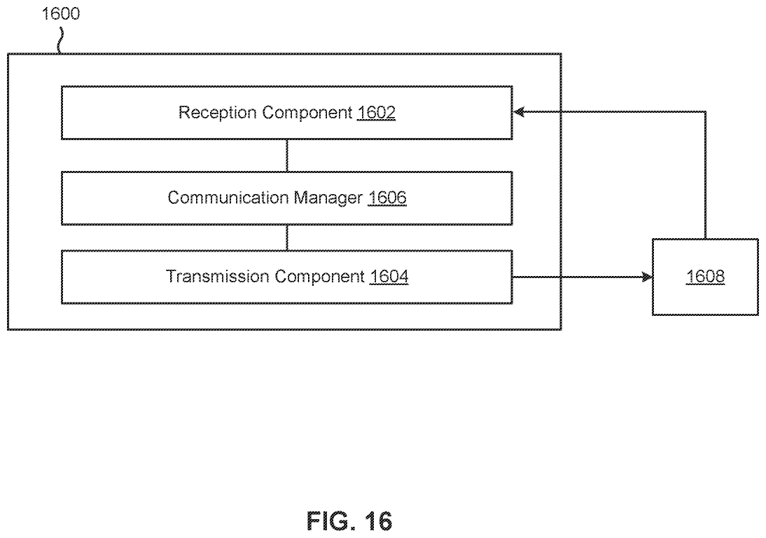

As shown in FIG. 12, in some aspects, process 1200 may include obtaining an indication of a geographical area associated with a network node (block 1210). For example, the AMF (e.g., using reception component 1602 and/or communication manager 1606, depicted in FIG. 16) may obtain an indication of a geographical area associated with a network node, as described above.

As further shown in FIG. 12, in some aspects, process 1200 may include transmitting an information element that indicates, for the geographical area, a resolution for the geographical area to be used for a broadcast transmission by the network node or a portion of the geographical area to be used for the broadcast transmission by the network node (block 1220). For example, the AMF (e.g., using transmission component 1604 and/or communication manager 1606, depicted in FIG. 16) may transmit an information element that indicates, for the geographical area, a resolution for the geographical area to be used for a broadcast transmission by the network node or a portion of the geographical area to be used for the broadcast transmission by the network node, as described above.

Process 1200 may include additional aspects, such as any single aspect or any combination of aspects described below and/or in connection with one or more other processes described elsewhere herein.

In a first aspect, transmitting the information element comprises transmitting, to the network node, an indication of the resolution for the geographical area to be used for the broadcast transmission by the network node.

In a second aspect, alone or in combination with the first aspect, the indication of the resolution for the geographical area includes an indication of a mapped beam or a mapped beam group associated with the geographical area.

In a third aspect, alone or in combination with one or more of the first and second aspects, the mapped beam or the mapped beam group is indexed with a unique beam identifier associated with a plurality of cells or a unique beam identifier within a cell associated with the network node.

In a fourth aspect, alone or in combination with one or more of the first through third aspects, process 1200 includes receiving, from the network node, an indication of a successful resource reservation or an indication of an unsuccessful resource reservation associated with the mapped beam or the mapped beam group.

In a fifth aspect, alone or in combination with one or more of the first through fourth aspects, transmitting the information element comprises transmitting, to the network node, an indication of the portion of the geographical area to be used for the broadcast transmission by the network node.

In a sixth aspect, alone or in combination with one or more of the first through fifth aspects, the indication of the portion of the geographical area is an indication of a target geographical area that includes at least one of a country indicator, a region indicator, or a zone indicator.

In a seventh aspect, alone or in combination with one or more of the first through sixth aspects, process 1200 includes receiving, from the network node, an indication of a successful resource reservation or an indication of an unsuccessful resource reservation for one or more indexes associated with the portion of the geographical area.

In an eighth aspect, alone or in combination with one or more of the first through seventh aspects, the network node is a non-terrestrial network node.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, at a network function or an apparatus of a network function, in accordance with the present disclosure. Example process 1300 is an example where the apparatus or the network function (e.g., network function 135) performs operations associated with network node broadcast transmissions.

As shown in FIG. 13, in some aspects, process 1300 may include detecting that a network node is to become available for a service area associated with performing broadcast transmissions (block 1310). For example, the network function (e.g., using communication manager 1606, depicted in FIG. 16) may detect that a network node is to become available for a service area associated with performing broadcast transmissions, as described above.

As further shown in FIG. 13, in some aspects, process 1300 may include transmitting a request for the network node to perform a broadcast transmission in accordance with the network node becoming available for the service area (block 1320). For example, the network function (e.g., using transmission component 1604 and/or communication manager 1606, depicted in FIG. 16) may transmit a request for the network node to perform a broadcast transmission in accordance with the network node becoming available for the service area, as described above.

Process 1300 may include additional aspects, such as any single aspect or any combination of aspects described below and/or in connection with one or more other processes described elsewhere herein.

In a first aspect, the network function is an AMF.

In a second aspect, alone or in combination with the first aspect, process 1300 includes selecting, by the AMF, the network node for performing the broadcast transmission.

In a third aspect, alone or in combination with one or more of the first and second aspects, selecting the network node for performing the broadcast transmission comprises selecting the network node based at least in part on satellite movement information.

In a fourth aspect, alone or in combination with one or more of the first through third aspects, the satellite movement information includes at least one of ephemeris information for each satellite of a plurality of satellites in the service area or timing information that indicates a time at which the network node is available for performing the broadcast transmission, wherein the satellite movement information is received from an operations, administration and maintenance server, an information server, or an upper layer node.

In a fifth aspect, alone or in combination with one or more of the first through fourth aspects, selecting the network node for performing the broadcast transmission comprises selecting the network node based at least in part on information received from the network node.

In a sixth aspect, alone or in combination with one or more of the first through fifth aspects, the information received from the network node includes at least one of an availability of the network node for performing the broadcast transmission or a time when the network node is available for performing the broadcast transmission, wherein the information received from the network node is indicated for each service of a plurality of services, for each service group of a plurality of service groups, for each message of a plurality of messages, or for each message group of a plurality of message groups.

In a seventh aspect, alone or in combination with one or more of the first through sixth aspects, process 1300 includes obtaining an indication of whether the AMF or the network node is to retain a broadcast message included in the broadcast transmission or to discard the broadcast message included in the broadcast transmission.

In an eighth aspect, alone or in combination with one or more of the first through seventh aspects, process 1300 includes receiving information that indicates whether the network node is to retain a broadcast message included in the broadcast transmission or to discard the broadcast message included in the broadcast transmission.

In a ninth aspect, alone or in combination with one or more of the first through eighth aspects, process 1300 includes transmitting, based at least in part on detecting a trigger, an indication for the network node to begin performing the broadcast transmission.

In a tenth aspect, alone or in combination with one or more of the first through ninth aspects, the trigger is associated with at least one of the AMF transmitting a broadcast request, the AMF transmitting a broadcast modification request, or the AMF detecting that the network node is becoming available for the service area.

In an eleventh aspect, alone or in combination with one or more of the first through tenth aspects, process 1300 includes transmitting, based at least in part on detecting a trigger, an indication for the network node to stop performing the broadcast transmission or an indication for the network node to suspend performing the broadcast transmission.

In a twelfth aspect, alone or in combination with one or more of the first through eleventh aspects, the trigger is associated with at least one of the AMF detecting that an upper layer node is requested, the AMF transmitting a broadcast modification request, or the AMF detecting that the network node is not available for the service area.

In a thirteenth aspect, alone or in combination with one or more of the first through twelfth aspects, process 1300 includes transmitting, based at least in part on timing information, an indication for the network node to begin performing the broadcast transmission, wherein the timing information includes at least one of an absolute time or a reference time plus a duration.

In a fourteenth aspect, alone or in combination with one or more of the first through thirteenth aspects, process 1300 includes transmitting, based at least in part on timing information, an indication for the network node to stop performing the broadcast transmission, wherein the timing information includes at least one of an absolute time or a reference time plus a duration.

In a fifteenth aspect, alone or in combination with one or more of the first through fourteenth aspects, transmitting the request for the network node to perform the broadcast transmission comprises transmitting, to a proxy configured to relay communications between the AMF and the network node, an indication for the network node to perform the broadcast transmission.

In a sixteenth aspect, alone or in combination with one or more of the first through fifteenth aspects, the network function is a CBCF or a PWS-IWF.

In a seventeenth aspect, alone or in combination with one or more of the first through sixteenth aspects, transmitting the request for the network node to perform the broadcast transmission comprises transmitting, by the CBCF or the PWS-IWF, based at least in part on satellite movement information, the request for the network node to perform the broadcast transmission.

In an eighteenth aspect, alone or in combination with one or more of the first through seventeenth aspects, the satellite movement information includes at least one of ephemeris information for each satellite of a plurality of satellites in the service area or timing information that indicates a time at which the network node is available for performing the broadcast transmission, wherein the satellite movement information is received from an operations, administration and maintenance server, an information server, or an upper layer node.

In a nineteenth aspect, alone or in combination with one or more of the first through eighteenth aspects, transmitting the request for the network node to perform the broadcast transmission comprises transmitting, by the CBCF or PWS-IWF, based at least in part on information received from an AMF, the request for the network node to perform the broadcast transmission.

In a twentieth aspect, alone or in combination with one or more of the first through nineteenth aspects, the information received from the AMF includes at least one of an availability of the network node for performing the broadcast transmission or a time when the network node is available for performing the broadcast transmission, wherein the information received from the network node is indicated for each service of a plurality of services, for each service group of a plurality of service groups, for each message of a plurality of messages, or for each message group of a plurality of message groups.

In a twenty-first aspect, alone or in combination with one or more of the first through twentieth aspects, the network node is a non-terrestrial network node.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, at a network node or an apparatus of a network node, in accordance with the present disclosure. Example process 1400 is an example where the apparatus or the network node (e.g., network node 110) performs operations associated with network node broadcast transmissions.

As shown in FIG. 14, in some aspects, process 1400 may include performing one or more movements in a direction of a service area associated with broadcast transmissions by the network node (block 1410). For example, the network node (e.g., using communication manager 1506, depicted in FIG. 15) may perform one or more movements in a direction of a service area associated with broadcast transmissions by the network node, as described above.

As further shown in FIG. 14, in some aspects, process 1400 may include receiving a request to perform a broadcast transmission in the service area in accordance with the one or more movements (block 1420). For example, the network node (e.g., using reception component 1502 and/or communication manager 1506, depicted in FIG. 15) may receive a request to perform a broadcast transmission in the service area in accordance with the one or more movements, as described above.

Process 1400 may include additional aspects, such as any single aspect or any combination of aspects described below and/or in connection with one or more other processes described elsewhere herein.

In a first aspect, receiving the request to perform the broadcast transmission comprises receiving, from an AMF, the request to perform the broadcast transmission.

In a second aspect, alone or in combination with the first aspect, receiving the request to perform the broadcast transmission comprises receiving the request to perform the broadcast transmission based at least in part on satellite movement information.

In a third aspect, alone or in combination with one or more of the first and second aspects, the satellite movement information includes at least one of ephemeris information for each satellite of a plurality of satellites in the service area or timing information that indicates a time at which the network node is available for performing the broadcast transmission, wherein the satellite movement information is received from an operations, administration and maintenance server, an information server, or an upper layer node.

In a fourth aspect, alone or in combination with one or more of the first through third aspects, receiving the request to perform the broadcast transmission comprises receiving the request to perform the broadcast transmission based at least in part on information transmitted by the network node.

In a fifth aspect, alone or in combination with one or more of the first through fourth aspects, the information transmitted by the network node includes at least one of an availability of the network node for performing the broadcast transmission or a time when the network node is available for performing the broadcast transmission, wherein the information transmitted by the network node is indicated for each service of a plurality of services, for each service group of a plurality of service groups, for each message of a plurality of messages, or for each message group of a plurality of message groups.

In a sixth aspect, alone or in combination with one or more of the first through fifth aspects, process 1400 includes obtaining an indication of whether the AMF or the network node is to retain a broadcast message included in the broadcast transmission or to discard the broadcast message included in the broadcast transmission.

In a seventh aspect, alone or in combination with one or more of the first through sixth aspects, process 1400 includes transmitting information that indicates whether the network node is to retain a broadcast message included in the broadcast transmission or to discard the broadcast message included in the broadcast transmission.

In an eighth aspect, alone or in combination with one or more of the first through seventh aspects, process 1400 includes receiving, based at least in part on an occurrence of a trigger, an indication for the network node to begin performing the broadcast transmission.

In a ninth aspect, alone or in combination with one or more of the first through eighth aspects, the trigger is associated with at least one of the AMF transmitting a broadcast request, the AMF transmitting a broadcast modification request, or the AMF detecting that the network node is becoming available for the service area.

In a tenth aspect, alone or in combination with one or more of the first through ninth aspects, process 1400 includes receiving, based at least in part on an occurrence of a trigger, an indication for the network node to stop performing the broadcast transmission or an indication for the network node to suspend performing the broadcast transmission.

In an eleventh aspect, alone or in combination with one or more of the first through tenth aspects, the trigger is associated with at least one of the AMF detecting that an upper layer node is requested, the AMF transmitting a broadcast modification request, or the AMF detecting that the network node is not available for the service area.

In a twelfth aspect, alone or in combination with one or more of the first through eleventh aspects, process 1400 includes receiving, based at least in part on timing information, an indication to begin performing the broadcast transmission, wherein the timing information includes at least one of an absolute time or a reference time plus a duration.

In a thirteenth aspect, alone or in combination with one or more of the first through twelfth aspects, process 1400 includes receiving, based at least in part on timing information, an indication to stop performing the broadcast transmission, wherein the timing information includes at least one of an absolute time or a reference time plus a duration.

In a fourteenth aspect, alone or in combination with one or more of the first through thirteenth aspects, process 1400 includes identifying, based at least in part on information stored at the network node, to begin performing the broadcast transmission.

In a fifteenth aspect, alone or in combination with one or more of the first through fourteenth aspects, the information stored at the network node includes at least one of a time at which the network node is available within a target area, a tracking area, a cell, or a beam, a time at which the network node is unavailable within the target area, the tracking area, the cell, or the beam, an indication that a memory size is available, or an indication that a processing power is available.

In a sixteenth aspect, alone or in combination with one or more of the first through fifteenth aspects, process 1400 includes identifying, based at least in part on information stored at the network node, to stop performing the broadcast transmission.

In a seventeenth aspect, alone or in combination with one or more of the first through sixteenth aspects, the information stored at the network node includes at least one of an indication that the network node is available or unavailable within a target area, a tracking area, a cell, or a beam, or an indication that a memory size or a processing power is available.

In an eighteenth aspect, alone or in combination with one or more of the first through seventeenth aspects, receiving the request to perform the broadcast transmission comprises receiving, from a proxy configured to relay communications between the AMF and the network node, an indication to perform the broadcast transmission.

In a nineteenth aspect, alone or in combination with one or more of the first through eighteenth aspects, receiving the request to perform the broadcast transmission comprises receiving, from a CBCF or PWS-IWF, the request to perform the broadcast transmission.

In a twentieth aspect, alone or in combination with one or more of the first through nineteenth aspects, receiving the request to perform the broadcast transmission comprises receiving, from the CBCF or PWS-IWF, based at least in part on satellite movement information, the request to perform the broadcast transmission.

In a twenty-first aspect, alone or in combination with one or more of the first through twentieth aspects, the satellite movement information includes at least one of ephemeris information for each satellite of a plurality of satellites in the service area or timing information that indicates a time at which the network node is available for performing the broadcast transmission, wherein the satellite movement information is received from an operations, administration and maintenance server, an information server, or an upper layer node.

In a twenty-second aspect, alone or in combination with one or more of the first through twenty-first aspects, receiving the request to perform the broadcast transmission comprises receiving, from the CBCF or PWS-IWF, based at least in part on information received from an AMF, the request to perform the broadcast transmission.

In a twenty-third aspect, alone or in combination with one or more of the first through twenty-second aspects, the information received from the AMF includes at least one of an availability of the network node for performing the broadcast transmission or a time when the network node is available for performing the broadcast transmission, wherein the information received from the network node is indicated for each service of a plurality of services, for each service group of a plurality of service groups, for each message of a plurality of messages, or for each message group of a plurality of message groups.

In a twenty-fourth aspect, alone or in combination with one or more of the first through twenty-third aspects, the network node is a non-terrestrial network node.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a network node, or a network node may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 150 described in connection with FIG. 1. As shown, the apparatus 1500 may communicate with another apparatus 1508, such as a UE or a network node (such as a CU, a DU, an RU, or a base station), using the reception component 1502 and the transmission component 1504.

In some aspects, the apparatus 1500 may be configured to perform one or more operations described herein in connection with FIGS. 5-10. Additionally, or alternatively, the apparatus 1500 may be configured to perform one or more processes described herein, such as process 1100 of FIG. 11, process 1400 of FIG. 14, or a combination thereof. In some aspects, the apparatus 1500 and/or one or more components shown in FIG. 15 may include one or more components of the network node described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1502 and/or the transmission component 1504 may include or may be included in a network interface. The network interface may be configured to obtain and/or output signals for the apparatus 1500 via one or more communications links, such as a backhaul link, a midhaul link, and/or a fronthaul link.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1508. In some aspects, the transmission component 1504 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1504 may be co-located with the reception component 1502 in one or more transceivers.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

The reception component 1502 may receive an information element that indicates, for a geographical area associated with the network node, a resolution for the geographical area to be used for a broadcast transmission by the network node or a portion of the geographical area to be used for the broadcast transmission by the network node. The communication manager 1506 may perform the broadcast transmission in accordance with the information element. The transmission component 1504 may transmit, to the AMF, an indication of a successful resource reservation or an indication of an unsuccessful resource reservation associated with the mapped beam or the mapped beam group. The transmission component 1504 may transmit, to the AMF, an indication of a successful resource reservation or an indication of an unsuccessful resource reservation for one or more indexes associated with the portion of the geographical area.

The reception component 1502 may receive a request to perform a broadcast transmission in the service area in accordance with the one or more movements. The reception component 1502 may obtain an indication of whether the AMF or the network node is to retain a broadcast message included in the broadcast transmission or to discard the broadcast message included in the broadcast transmission. The transmission component 1504 may transmit information that indicates whether the network node is to retain a broadcast message included in the broadcast transmission or to discard the broadcast message included in the broadcast transmission. The reception component 1502 may receive, based at least in part on an occurrence of a trigger, an indication for the network node to begin performing the broadcast transmission. The reception component 1502 may receive, based at least in part on an occurrence of a trigger, an indication for the network node to stop performing the broadcast transmission or an indication for the network node to suspend performing the broadcast transmission. The reception component 1502 may receive, based at least in part on timing information, an indication to begin performing the broadcast transmission, wherein the timing information includes at least one of an absolute time or a reference time plus a duration. The reception component 1502 may receive, based at least in part on timing information, an indication to stop performing the broadcast transmission, wherein the timing information includes at least one of an absolute time or a reference time plus a duration. The communication manager 1506 may identify, based at least in part on information stored at the network node, to begin performing the broadcast transmission. The communication manager 1506 may identify, based at least in part on information stored at the network node, to stop performing the broadcast transmission.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication, in accordance with the present disclosure. The apparatus 1600 may be a network function, or a network function may include the apparatus 1600. In some aspects, the apparatus 1600 includes a reception component 1602, a transmission component 1604, and/or a communication manager 1606, which may be in communication with one another (for example, via one or more buses and/or one or more other components). In some aspects, the communication manager 1606 is the communication manager 140 described in connection with FIG. 1. As shown, the apparatus 1600 may communicate with another apparatus 1608, such as a UE or a network node (such as a CU, a DU, an RU, or a base station), using the reception component 1602 and the transmission component 1604.

In some aspects, the apparatus 1600 may be configured to perform one or more operations described herein in connection with FIGS. 5-10. Additionally, or alternatively, the apparatus 1600 may be configured to perform one or more processes described herein, such as process 1200 of FIG. 12, process 1300 of FIG. 13, or a combination thereof. In some aspects, the apparatus 1600 and/or one or more components shown in FIG. 16 may include one or more components of the network function described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1602 may receive communications, such as reference signals, control information, data communications, or a combination thereof, from the apparatus 1608. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, one or more modems, one or more demodulators, one or more MIMO detectors, one or more receive processors, one or more controllers/processors, one or more memories, or a combination thereof, of the network function described in connection with FIG. 2.

The transmission component 1604 may transmit communications, such as reference signals, control information, data communications, or a combination thereof, to the apparatus 1608. In some aspects, one or more other components of the apparatus 1600 may generate communications and may provide the generated communications to the transmission component 1604 for transmission to the apparatus 1608. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1608. In some aspects, the transmission component 1604 may include one or more antennas, one or more modems, one or more modulators, one or more transmit MIMO processors, one or more transmit processors, one or more controllers/processors, one or more memories, or a combination thereof, of the network function described in connection with FIG. 2. In some aspects, the transmission component 1604 may be co-located with the reception component 1602 in one or more transceivers.

The communication manager 1606 may support operations of the reception component 1602 and/or the transmission component 1604. For example, the communication manager 1606 may receive information associated with configuring reception of communications by the reception component 1602 and/or transmission of communications by the transmission component 1604. Additionally, or alternatively, the communication manager 1606 may generate and/or provide control information to the reception component 1602 and/or the transmission component 1604 to control reception and/or transmission of communications.

The transmission component 1604 may transmit a request for the network node to perform a broadcast transmission in accordance with the network node becoming available for the service area. The communication manager 1606 may select the network node for performing the broadcast transmission. The reception component 1602 may obtain an indication of whether the AMF or the network node is to retain a broadcast message included in the broadcast transmission or to discard the broadcast message included in the broadcast transmission. The reception component 1602 may receive information that indicates whether the network node is to retain a broadcast message included in the broadcast transmission or to discard the broadcast message included in the broadcast transmission. The transmission component 1604 may transmit, based at least in part on detecting a trigger, an indication for the network node to begin performing the broadcast transmission. The transmission component 1604 may transmit, based at least in part on detecting a trigger, an indication for the network node to stop performing the broadcast transmission or an indication for the network node to suspend performing the broadcast transmission. The transmission component 1604 may transmit, based at least in part on timing information, an indication for the network node to begin performing the broadcast transmission, wherein the timing information includes at least one of an absolute time or a reference time plus a duration. The transmission component 1604 may transmit, based at least in part on timing information, an indication for the network node to stop performing the broadcast transmission or an indication for the network node to suspend performing the broadcast transmission, wherein the timing information includes at least one of an absolute time or a reference time plus a duration.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:

Aspect 1: A method of wireless communication performed by a network node, comprising: receiving an information element that indicates, for a geographical area associated with the network node, a resolution for the geographical area to be used for a broadcast transmission by the network node or a portion of the geographical area to be used for the broadcast transmission by the network node; and performing the broadcast transmission in accordance with the information element.

Aspect 2: The method of Aspect 1, wherein receiving the information element comprises receiving, from an access and mobility management function (AMF), an indication of the resolution for the geographical area to be used for the broadcast transmission by the network node.

Aspect 3: The method of Aspect 2, wherein the indication of the resolution for the geographical area includes an indication of a mapped beam or a mapped beam group associated with the geographical area.

Aspect 4: The method of Aspect 3, wherein performing the broadcast transmission in accordance with the information element comprises performing the broadcast transmission using the mapped beam or the mapped beam group.

Aspect 5: The method of Aspect 3, wherein the mapped beam or the mapped beam group is indexed with a unique beam identifier associated with a plurality of cells or a unique beam identifier within a cell associated with the network node.

Aspect 6: The method of Aspect 3, further comprising transmitting, to the AMF, an indication of a successful resource reservation or an indication of an unsuccessful resource reservation associated with the mapped beam or the mapped beam group.

Aspect 7: The method of any of Aspects 1-6, wherein receiving the information element comprises receiving, from an access and mobility management function (AMF), an indication of the portion of the geographical area to be used for the broadcast transmission by the network node.

Aspect 8: The method of Aspect 7, wherein the indication of the portion of the geographical area is an indication of a target geographical area that includes at least one of a country indicator, a region indicator, or a zone indicator.

Aspect 9: The method of Aspect 7, wherein performing the broadcast transmission in accordance with the information element comprises performing the broadcast transmission within the portion of the geographical area.

Aspect 10: The method of Aspect 7, further comprising transmitting, to the AMF, an indication of a successful resource reservation or an indication of an unsuccessful resource reservation for one or more indexes associated with the portion of the geographical area.

Aspect 11: The method of any of Aspects 1-10, wherein the network node is a non-terrestrial network node.

Aspect 12: A method of wireless communication performed by an access and mobility management function (AMF), comprising: obtaining an indication of a geographical area associated with a network node; and transmitting an information element that indicates, for the geographical area, a resolution for the geographical area to be used for a broadcast transmission by the network node or a portion of the geographical area to be used for the broadcast transmission by the network node.

Aspect 13: The method of Aspect 12, wherein transmitting the information element comprises transmitting, to the network node, an indication of the resolution for the geographical area to be used for the broadcast transmission by the network node.

Aspect 14: The method of Aspect 13, wherein the indication of the resolution for the geographical area includes an indication of a mapped beam or a mapped beam group associated with the geographical area.

Aspect 15: The method of Aspect 14, wherein the mapped beam or the mapped beam group is indexed with a unique beam identifier associated with a plurality of cells or a unique beam identifier within a cell associated with the network node.

Aspect 16: The method of Aspect 14, further comprising receiving, from the network node, an indication of a successful resource reservation or an indication of an unsuccessful resource reservation associated with the mapped beam or the mapped beam group.

Aspect 17: The method of any of Aspects 12-16, wherein transmitting the information element comprises transmitting, to the network node, an indication of the portion of the geographical area to be used for the broadcast transmission by the network node.

Aspect 18: The method of Aspect 17, wherein the indication of the portion of the geographical area is an indication of a target geographical area that includes at least one of a country indicator, a region indicator, or a zone indicator.

Aspect 19: The method of Aspect 18, further comprising receiving, from the network node, an indication of a successful resource reservation or an indication of an unsuccessful resource reservation for one or more indexes associated with the portion of the geographical area.

Aspect 20: The method of any of Aspects 12-19, wherein the network node is a non-terrestrial network node.

Aspect 21: A method of wireless communication performed by a network function, comprising: detecting that a network node is to become available for a service area associated with performing broadcast transmissions; and transmitting a request for the network node to perform a broadcast transmission in accordance with the network node becoming available for the service area.

Aspect 22: The method of Aspect 21, wherein the network function is an access and mobility management function (AMF) or a mobility management entity (MME).

Aspect 23: The method of Aspect 22, further comprising selecting, by the AMF, the network node for performing the broadcast transmission.

Aspect 24: The method of Aspect 23, wherein selecting the network node for performing the broadcast transmission comprises selecting the network node based at least in part on satellite movement information.

Aspect 25: The method of Aspect 24, wherein the satellite movement information includes at least one of ephemeris information for each satellite of a plurality of satellites in the service area or timing information that indicates a time at which the network node is available for performing the broadcast transmission, wherein the satellite movement information is received from an operations, administration and maintenance server, an information server, or an upper layer node.

Aspect 26: The method of Aspect 23, wherein selecting the network node for performing the broadcast transmission comprises selecting the network node based at least in part on information received from the network node.

Aspect 27: The method of Aspect 26, wherein the information received from the network node includes at least one of an availability of the network node for performing the broadcast transmission or a time when the network node is available for performing the broadcast transmission, wherein the information received from the network node is indicated for each service of a plurality of services, for each service group of a plurality of service groups, for each message of a plurality of messages, or for each message group of a plurality of message groups.

Aspect 28: The method of Aspect 22, further comprising obtaining an indication of whether the AMF or the network node is to retain a broadcast message included in the broadcast transmission or to discard the broadcast message included in the broadcast transmission.

Aspect 29: The method of Aspect 22, further comprising receiving information that indicates whether the network node is to retain a broadcast message included in the broadcast transmission or to discard the broadcast message included in the broadcast transmission.

Aspect 30: The method of Aspect 22, further comprising transmitting, based at least in part on detecting a trigger, an indication for the network node to begin performing the broadcast transmission.

Aspect 31: The method of Aspect 30, wherein the trigger is associated with at least one of the AMF transmitting a broadcast request, the AMF transmitting a broadcast modification request, or the AMF detecting that the network node is becoming available for the service area.

Aspect 32: The method of Aspect 22, further comprising transmitting, based at least in part on detecting a trigger, an indication for the network node to stop performing the broadcast transmission or an indication for the network node to suspend performing the broadcast transmission.

Aspect 33: The method of Aspect 32, wherein the trigger is associated with at least one of the AMF detecting that an upper layer node is requested, the AMF transmitting a broadcast modification request, or the AMF detecting that the network node is not available for the service area.

Aspect 34: The method of Aspect 22, further comprising transmitting, based at least in part on timing information, an indication for the network node to begin performing the broadcast transmission, wherein the timing information includes at least one of an absolute time or a reference time plus a duration.

Aspect 35: The method of Aspect 22, further comprising transmitting, based at least in part on timing information, an indication for the network node to stop performing the broadcast transmission, wherein the timing information includes at least one of an absolute time or a reference time plus a duration.

Aspect 36: The method of Aspect 22, wherein transmitting the request for the network node to perform the broadcast transmission comprises transmitting, to a proxy configured to relay communications between the AMF and the network node, an indication for the network node to perform the broadcast transmission.

Aspect 37: The method of any of Aspects 21-36, wherein the network function is a cell broadcast center function (CBCF) or a public warning system interworking function (PWS-IWF).

Aspect 38: The method of Aspect 37, wherein transmitting the request for the network node to perform the broadcast transmission comprises transmitting, by the CBCF or the PWS-IWF, based at least in part on satellite movement information, the request for the network node to perform the broadcast transmission.

Aspect 39: The method of Aspect 38, wherein the satellite movement information includes at least one of ephemeris information for each satellite of a plurality of satellites in the service area or timing information that indicates a time at which the network node is available for performing the broadcast transmission, wherein the satellite movement information is received from an operations, administration and maintenance server, an information server, or an upper layer node.

Aspect 40: The method of Aspect 37, wherein transmitting the request for the network node to perform the broadcast transmission comprises transmitting, by the CBCF or PWS-IWF, based at least in part on information received from an access and mobility management function (AMF), the request for the network node to perform the broadcast transmission.

Aspect 41: The method of Aspect 40, wherein the information received from the AMF includes at least one of an availability of the network node for performing the broadcast transmission or a time when the network node is available for performing the broadcast transmission, wherein the information received from the network node is indicated for each service of a plurality of services, for each service group of a plurality of service groups, for each message of a plurality of messages, or for each message group of a plurality of message groups.

Aspect 42: The method of any of Aspects 21-41, wherein the network node is a non-terrestrial network node.

Aspect 43: A method of wireless communication performed by a network node, comprising: performing one or more movements in a direction of a service area associated with broadcast transmissions by the network node; and receiving a request to perform a broadcast transmission in the service area in accordance with the one or more movements.

Aspect 44: The method of Aspect 43, wherein receiving the request to perform the broadcast transmission comprises receiving, from an access and mobility management function (AMF), the request to perform the broadcast transmission.

Aspect 45: The method of Aspect 44, wherein receiving the request to perform the broadcast transmission comprises receiving the request to perform the broadcast transmission based at least in part on satellite movement information.

Aspect 46: The method of Aspect 45, wherein the satellite movement information includes at least one of ephemeris information for each satellite of a plurality of satellites in the service area or timing information that indicates a time at which the network node is available for performing the broadcast transmission, wherein the satellite movement information is received from an operations, administration and maintenance server, an information server, or an upper layer node.

Aspect 47: The method of Aspect 44, wherein receiving the request to perform the broadcast transmission comprises receiving the request to perform the broadcast transmission based at least in part on information transmitted by the network node.

Aspect 48: The method of Aspect 47, wherein the information transmitted by the network node includes at least one of an availability of the network node for performing the broadcast transmission or a time when the network node is available for performing the broadcast transmission, wherein the information transmitted by the network node is indicated for each service of a plurality of services, for each service group of a plurality of service groups, for each message of a plurality of messages, or for each message group of a plurality of message groups.

Aspect 49: The method of Aspect 44, further comprising obtaining an indication of whether the AMF or the network node is to retain a broadcast message included in the broadcast transmission or to discard the broadcast message included in the broadcast transmission.

Aspect 50: The method of Aspect 44, further comprising transmitting information that indicates whether the network node is to retain a broadcast message included in the broadcast transmission or to discard the broadcast message included in the broadcast transmission.

Aspect 51: The method of Aspect 44, further comprising receiving, based at least in part on an occurrence of a trigger, an indication for the network node to begin performing the broadcast transmission.

Aspect 52: The method of Aspect 51, wherein the trigger is associated with at least one of the AMF transmitting a broadcast request, the AMF transmitting a broadcast modification request, or the AMF detecting that the network node is becoming available for the service area.

Aspect 53: The method of Aspect 44, further comprising receiving, based at least in part on an occurrence of a trigger, an indication for the network node to stop performing the broadcast transmission or an indication for the network node to suspend performing the broadcast transmission.

Aspect 54: The method of Aspect 53, wherein the trigger is associated with at least one of the AMF detecting that an upper layer node is requested, the AMF transmitting a broadcast modification request, or the AMF detecting that the network node is not available for the service area.

Aspect 55: The method of Aspect 44, further comprising receiving, based at least in part on timing information, an indication to begin performing the broadcast transmission, wherein the timing information includes at least one of an absolute time or a reference time plus a duration.

Aspect 56: The method of Aspect 44, further comprising receiving, based at least in part on timing information, an indication to stop performing the broadcast transmission, wherein the timing information includes at least one of an absolute time or a reference time plus a duration.

Aspect 57: The method of Aspect 44, further comprising identifying, based at least in part on information stored at the network node, to begin performing the broadcast transmission.

Aspect 58: The method of Aspect 57, wherein the information stored at the network node includes at least one of a time at which the network node is available within a target area, a tracking area, a cell, or a beam, a time at which the network node is unavailable within the target area, the tracking area, the cell, or the beam, an indication that a memory size is available, or an indication that a processing power is available.

Aspect 59: The method of Aspect 44, further comprising identifying, based at least in part on information stored at the network node, to stop performing the broadcast transmission.

Aspect 60: The method of Aspect 59, wherein the information stored at the network node includes at least one of an indication that the network node is available or unavailable within a target area, a tracking area, a cell, or a beam, or an indication that a memory size or a processing power is available.

Aspect 61: The method of Aspect 44, wherein receiving the request to perform the broadcast transmission comprises receiving, from a proxy configured to relay communications between the AMF and the network node, an indication to perform the broadcast transmission.

Aspect 62: The method of any of Aspects 43-61, wherein receiving the request to perform the broadcast transmission comprises receiving, from a cell broadcast center function (CBCF) or public warning system interworking function (PWS-IWF), the request to perform the broadcast transmission.

Aspect 63: The method of Aspect 62, wherein receiving the request to perform the broadcast transmission comprises receiving, from the CBCF or PWS-IWF, based at least in part on satellite movement information, the request to perform the broadcast transmission.

Aspect 64: The method of Aspect 63, wherein the satellite movement information includes at least one of ephemeris information for each satellite of a plurality of satellites in the service area or timing information that indicates a time at which the network node is available for performing the broadcast transmission, wherein the satellite movement information is received from an operations, administration and maintenance server, an information server, or an upper layer node.

Aspect 65: The method of Aspect 62, wherein receiving the request to perform the broadcast transmission comprises receiving, from the CBCF or PWS-IWF, based at least in part on information received from an access and mobility management function (AMF), the request to perform the broadcast transmission.

Aspect 66: The method of Aspect 65, wherein the information received from the AMF includes at least one of an availability of the network node for performing the broadcast transmission or a time when the network node is available for performing the broadcast transmission, wherein the information received from the network node is indicated for each service of a plurality of services, for each service group of a plurality of service groups, for each message of a plurality of messages, or for each message group of a plurality of message groups.

Aspect 67: The method of any of Aspects 43-66, wherein the network node is a non-terrestrial network node.

Aspect 68: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-67.

Aspect 69: An apparatus for wireless communication at a device, the apparatus comprising one or more memories and one or more processors coupled to the one or more memories, the one or more processors configured to cause the device to perform the method of one or more of Aspects 1-67.

Aspect 70: An apparatus for wireless communication, the apparatus comprising at least one means for performing the method of one or more of Aspects 1-67.

Aspect 71: A non-transitory computer-readable medium storing code for wireless communication, the code comprising instructions executable by one or more processors to perform the method of one or more of Aspects 1-67.

Aspect 72: A non-transitory computer-readable medium storing a set of instructions for wireless communication, the set of instructions comprising one or more instructions that, when executed by one or more processors of a device, cause the device to perform the method of one or more of Aspects 1-67.

Aspect 73: A device for wireless communication, the device comprising a processing system that includes one or more processors and one or more memories coupled with the one or more processors, the processing system configured to cause the device to perform the method of one or more of Aspects 1-67.

Aspect 74: An apparatus for wireless communication at a device, the apparatus comprising one or more memories and one or more processors coupled to the one or more memories, the one or more processors individually or collectively configured to cause the device to perform the method of one or more of Aspects 1-67.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a network node, comprising:
one or more memories; and
one or more processors, coupled to the one or more memories, configured to cause the network node to:
receive an information element that indicates, for a geographical area associated with the network node, a resolution for the geographical area to be used for a broadcast transmission by the network node or a portion of the geographical area to be used for the broadcast transmission by the network node; and
perform the broadcast transmission in accordance with the information element.

2. The apparatus of claim 1, wherein the one or more processors, to cause the network node to receive the information element, are configured to cause the network node to receive, from an access and mobility management function (AMF), an indication of the resolution for the geographical area to be used for the broadcast transmission by the network node.

3. The apparatus of claim 2, wherein the indication of the resolution for the geographical area includes an indication of a mapped beam or a mapped beam group associated with the geographical area.

4. The apparatus of claim 3, wherein the mapped beam or the mapped beam group is indexed with a unique beam identifier associated with a plurality of cells or a unique beam identifier within a cell associated with the network node.

5. The apparatus of claim 1, wherein the one or more processors, to cause the network node to receive the information element, are configured to cause the network node to receive, from an access and mobility management function (AMF), an indication of the portion of the geographical area to be used for the broadcast transmission by the network node, wherein the indication of the portion of the geographical area is an indication of a target geographical area that includes at least one of a country indicator, a region indicator, or a zone indicator.

6. The apparatus of claim 5, wherein the information element that indicates the resolution for the geographical area or the portion of the geographical area is an information element to be used for broadcast transmissions by the network node or for multicast transmissions by the network node, and wherein the one or more processors, to cause the network node to perform the broadcast transmission in accordance with the information element, are configured to cause the network node to perform at least one of the broadcast transmission or a multicast transmission in accordance with the information element.

7. An apparatus for wireless communication at an access and mobility management function (AMF), comprising:
one or more memories; and
one or more processors, coupled to the one or more memories, configured to cause the AMF to:
obtain an indication of a geographical area associated with a network node; and
transmit an information element that indicates, for the geographical area, a resolution for the geographical area to be used for a broadcast transmission by the network node or a portion of the geographical area to be used for the broadcast transmission by the network node.

8. The apparatus of claim 7, wherein the one or more processors, to cause the AMF to transmit the information element, are configured to cause the AMF to transmit, to the network node, an indication of the resolution for the geographical area to be used for the broadcast transmission by the network node.

9. The apparatus of claim 8, wherein the indication of the resolution for the geographical area includes an indication of a mapped beam or a mapped beam group associated with the geographical area.

10. The apparatus of claim 9, wherein the mapped beam or the mapped beam group is indexed with a unique beam identifier associated with a plurality of cells or a unique beam identifier within a cell associated with the network node.

11. The apparatus of claim 7, wherein the one or more processors, to cause the AMF to transmit the information element, are configured to cause the AMF to transmit, to the network node, an indication of the portion of the geographical area to be used for the broadcast transmission by the network node, wherein the indication of the portion of the geographical area is an indication of a target geographical area that includes at least one of a country indicator, a region indicator, or a zone indicator.

12. The apparatus of claim 11, wherein the information element that indicates the resolution for the geographical area or the portion of the geographical area is an information element to be used for broadcast transmissions by the network node or multicast transmissions by the network node.

13. An apparatus for wireless communication at a network function, comprising:
one or more memories; and
one or more processors, coupled to the one or more memories, configured to cause the network function to:
detect that a network node is to become available for a service area associated with performing broadcast transmissions; and
transmit a request for the network node to perform a broadcast transmission in accordance with the network node becoming available for the service area.

14. The apparatus of claim 13, wherein the network function is an access and mobility management function (AMF) or a mobility management entity (MME).

15. The apparatus of claim 14, wherein the one or more processors are further configured to cause the network function to select the network node for performing the broadcast transmission.

16. The apparatus of claim 15, wherein the one or more processors, to cause the network function to select the network node for performing the broadcast transmission, are configured to cause the network function to select the network node based at least in part on satellite movement information, wherein the satellite movement information includes at least one of ephemeris information for each satellite of a plurality of satellites in the service area or timing information that indicates a time at which the network node is available for performing the broadcast transmission, wherein the satellite movement information is received from an operations, administration and maintenance server, an information server, or an upper layer node.

17. The apparatus of claim 15, wherein the one or more processors, to cause the network function to select the network node for performing the broadcast transmission, are configured to cause the network function to select the network node based at least in part on information received from the network node, wherein the information received from the network node includes at least one of an availability of the network node for performing the broadcast transmission or a time when the network node is available for performing the broadcast transmission, and wherein the information received from the network node is indicated for each service of a plurality of services, for each service group of a plurality of service groups, for each message of a plurality of messages, or for each message group of a plurality of message groups.

18. The apparatus of claim 14, wherein the one or more processors are further configured to cause the network function to obtain an indication of whether the AMF or the network node is to retain a broadcast message included in the broadcast transmission or to discard the broadcast message included in the broadcast transmission.

19. The apparatus of claim 14, wherein the one or more processors are further configured to cause the network function to receive information that indicates whether the network node is to retain a broadcast message included in the broadcast transmission or to discard the broadcast message included in the broadcast transmission.

20. The apparatus of claim 14, wherein the one or more processors are further configured to cause the network function to transmit, based at least in part on detecting a trigger, an indication for the network node to begin performing the broadcast transmission, wherein the trigger is associated with at least one of the AMF transmitting a broadcast request, the AMF transmitting a broadcast modification request, or the AMF detecting that the network node is available for the service area.

21. The apparatus of claim 14, wherein the one or more processors are further configured to cause the network function to transmit, based at least in part on detecting a trigger, an indication for the network node to stop performing the broadcast transmission or an indication for the network node to suspend performing the broadcast transmission, wherein the trigger is associated with at least one of the AMF detecting that an upper layer node is requested, the AMF transmitting a broadcast modification request, or the AMF detecting that the network node is not available for the service area.

22. The apparatus of claim 14, wherein the one or more processors are further configured to cause the network function to transmit, based at least in part on timing information, an indication for the network node to begin performing the broadcast transmission, wherein the timing information includes at least one of an absolute time or a reference time plus a duration.

23. The apparatus of claim 14, wherein the one or more processors are further configured to cause the network function to transmit, based at least in part on timing information, an indication for the network node to stop performing the broadcast transmission, wherein the timing information includes at least one of an absolute time or a reference time plus a duration.

24. The apparatus of claim 14, wherein the one or more processors, to cause the network function to transmit the request for the network node to perform the broadcast transmission, are configured to cause the network function to transmit, to a proxy configured to relay communications between the AMF and the network node, an indication for the network node to perform the broadcast transmission.

25. The apparatus of claim 13, wherein the network function is a cell broadcast center function (CBCF) or a public warning system interworking function (PWS-IWF).

26. The apparatus of claim 25, wherein the one or more processors, to cause the network function to transmit the request for the network node to perform the broadcast transmission, are configured to cause the network function to transmit, by the CBCF or the PWS-IWF, based at least in part on satellite movement information, the request for the network node to perform the broadcast transmission.

27. The apparatus of claim 25, wherein the one or more processors, to cause the network function to transmit the request for the network node to perform the broadcast transmission, are configured to cause the network function to transmit, by the CBCF or PWS-IWF, based at least in part on information received from an access and mobility management function (AMF), the request for the network node to perform the broadcast transmission.

28. An apparatus for wireless communication at a network node, comprising:
one or more memories; and
one or more processors, coupled to the one or more memories, configured to cause the network node to:
perform one or more movements in a direction of a service area associated with broadcast transmissions by the network node; and
receive a request to perform a broadcast transmission in the service area in accordance with the one or more movements.

29. The apparatus of claim 28, wherein the one or more processors, to cause the network node to receive the request to perform the broadcast transmission, are configured to cause the network node to receive, from an access and mobility management function (AMF), cell broadcast center function (CBCF), or a public warning system interworking function (PWS-IWF), the request to perform the broadcast transmission.

30. The apparatus of claim 29, wherein the one or more processors, to cause the network node to receive the request to perform the broadcast transmission, are configured to cause the network node to receive the request to perform the broadcast transmission based at least in part on satellite movement information or based at least in part on information transmitted by the network node.
